(19) United States
(12) Patent Application Publication
(10) Pub. No.: US 2026/0285153 A1
(43) Pub. Date: Sep. 24, 2026

(54) CONTENT CONTROL DEVICE, CONTENT CONTROL METHOD, STORAGE MEDIUM, AND CONTENT CONTROL SYSTEM

(71) Applicant: HONDA MOTOR CO., LTD., Tokyo (JP)

(72) Inventor: Takashi Noguchi, Tokyo (JP)

(21) Appl. No.: 19/446,428

(22) Filed: Jan. 12, 2026

(30) Foreign Application Priority Data
Mar. 18, 2025 (JP) 2025-043202

(51) Int. Cl. B60K 35/28; G06F 16/906; G06V 20/59

(52) U.S. Cl. CPC B60K 35/28; G06F 16/906; G06V 20/593

(57) ABSTRACT

A content control device includes: a first content output unit that outputs a content to a passenger seated on a seat in a vehicle; an output control unit that controls the content output by the first content output unit; an in-vehicle history storage unit that stores an in-vehicle output history; and an outside-vehicle history acquisition unit that acquires an outside-vehicle output history, and the output control unit calculates a similarity indicating the degree of similarity between the in-vehicle output history and the outside-vehicle output history, and controls the content output by the first content output unit according to the similarity.

### INCORPORATION BY REFERENCE

The present application claims priority under 35 U.S.C. § 119 to Japanese Patent Application No. 2025-043202 filed on Mar. 18, 2025. The content of the application is incorporated herein by reference in its entirety.

### BACKGROUND OF THE INVENTION

### Field of the Invention

The present invention relates to a content control device, a content control method, a storage medium, and a content control system.

### Description of the Related Art

Japanese Patent Laid-Open No. 2003-174377 discloses a technique that includes receiving and storing contents and metadata thereof, calculating an index indicating a presentation priority for each viewer using an automatic selection presentation program with respect to a plurality of broadcast service contents which are transmitted and stored, and selecting and continuously presenting the plurality of broadcast service contents according to the index.

However, the invention disclosed in Japanese Patent Laid-Open No. 2003-174377 controls a content delivery in a limited usage situation, namely, in a vehicle. However, in recent years, it is considered that the same application is used in various situations, for example, in a vehicle, at home, and on a train. Therefore, it is necessary to consider not only the vehicle but also various situations, a user has different use tendency of the content depending on situations, and thus there is need to control the content suitable for a passenger of the vehicle.

In other words, there is a problem of controlling the content suitable for the passenger of the vehicle according to the use tendency of the content outside the vehicle.

### SUMMARY OF THE INVENTION

In order to achieve the above object, a first aspect of the present invention provides a content control device including: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit calculates a similarity indicating the degree of similarity between the in-vehicle output history and the outside-vehicle output history, and controls the content output by the content output unit according to the similarity.

In order to achieve the above object, a second aspect of the present invention provides a content control method performed by a content control device, the content control device including: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit executes a content control step of calculating a similarity indicating the degree of similarity between the in-vehicle output history and the outside-vehicle output history, and controlling the content output by the content output unit according to the similarity.

In order to achieve the above object, a third aspect of the present invention provides a non-transitory computer readable storage medium storing a content control program causes a processor provided in a content control device arranged in a vehicle to function as: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit executes a content control step of calculating a similarity indicating the degree of similarity between the in-vehicle output history and the outside-vehicle output history, and controlling the content output by the content output unit according to the similarity.

In order to achieve the above object, a fourth aspect of the present invention provides a content control system including: a content control device; and an information processing device communicably connected to the content control device, the content control device including: a content output unit that outputs a content to a passenger seated on a seat in a vehicle; an output control unit that controls the content output by the content output unit; and a history storage unit that classifies the content output by the content output unit according to each of types of the content and stores, as an in-vehicle output history, the number of occurrences of output of the content for each of the types of the content in association with the passenger, in which, the content control device further includes an outside-vehicle history acquisition unit that classifies a content output outside the vehicle from the information processing device by the passenger according to each of types of the content and acquires, as an outside-vehicle output history, the number of occurrences of output of the content for each of the types of the content, and the output control unit calculates a similarity indicating the degree of similarity between the in-vehicle output history and the outside-vehicle output history, and controls the content output by the content output unit according to the similarity.

According to the content control device, the content control method, the storage medium, and the content control system described above, it is possible to control the content suitable for the passenger of the vehicle according to the use tendency of the content outside the vehicle.

### BRIEF DESCRIPTION OF THE DRAWINGS

FIG. 1 is a diagram illustrating an example of a configuration of a content control system according to the present embodiment;

FIG. 2 is a plan view illustrating an example of a configuration of a vehicle mounted with a content control device according to the present embodiment;

FIG. 3 is a diagram illustrating an example of a configuration of the content control device according to the present embodiment;

FIG. 4 is a table illustrating an example of a case where an in-vehicle output history and an outside-vehicle output history are similar to each other;

FIG. 5 is a table illustrating an example of a case where an in-vehicle output history and an outside-vehicle output history are not similar to each other;

FIG. 6 is a table illustrating an example of an in-vehicle output history when a passenger is seated on a driver's seat and an in-vehicle output history when a passenger is seated on a passenger seat;

FIG. 7 is a table illustrating an example of in-vehicle output history when the number of passengers is one and in-vehicle output histories corresponding to the other passenger when the number of passengers is two;

FIG. 8 is a table illustrating an example of an in-vehicle output history and outside-vehicle output histories which are different in outside-vehicle environment information from each other; and

FIG. 9 is a flowchart illustrating an example of processing of the content control device according to the present embodiment.

### DETAILED DESCRIPTION OF THE INVENTION

Hereinafter, embodiments of a content control device, a content control method, a content control program, and a content control system will be described with reference to the drawings.

### 1. CONFIGURATION OF CONTENT CONTROL SYSTEM

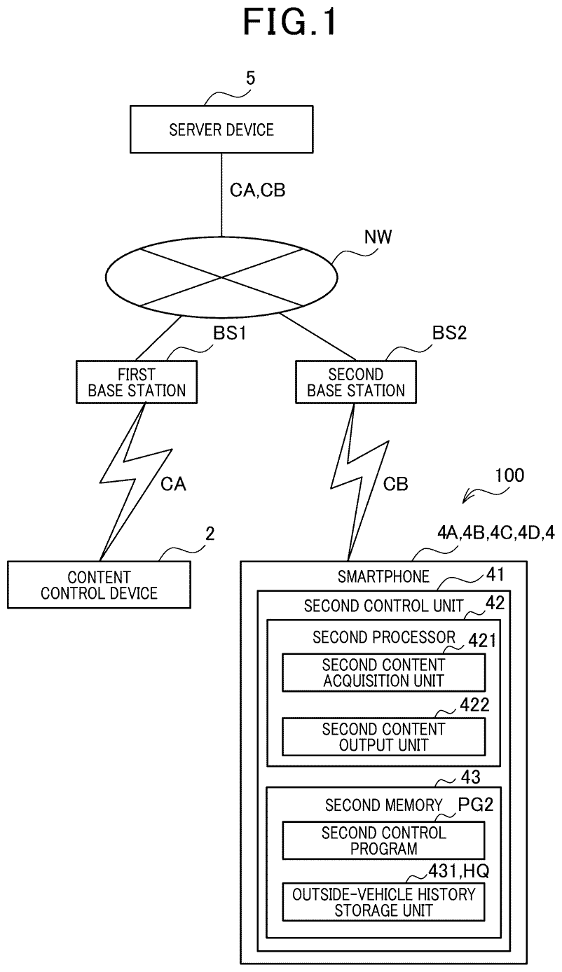

First, a configuration of a content control system 100 according to the present embodiment will be described with reference to FIG. 1. FIG. 1 is a diagram illustrating an example of the content control system 100 according to the present embodiment.

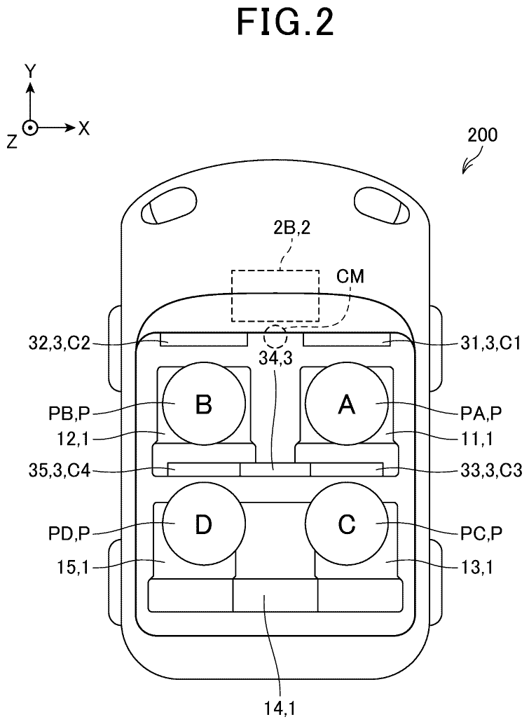

The content control system 100 includes a content control device 2 and a smartphone 4. The content control device 2 is mounted on a vehicle 200 as illustrated in FIG. 2. The smartphone 4 is communicably connected to the content control device 2. The smartphone 4 is a smartphone owned by a passenger P in the vehicle 200.

As illustrated in FIG. 2, the passenger P includes a passenger PA, a passenger PB, a passenger PC, and a passenger PD. The smartphone 4 includes a smartphone 4A, a smartphone 4B, a smartphone 4C, and a smartphone 4D. The smartphone 4A is a smartphone owned by the passenger PA. The smartphone 4B is a smartphone owned by the passenger PB. The smartphone 4C is a smartphone owned by the passenger PC. The smartphone 4D is a smartphone owned by the passenger PD.

In the following description, the passenger PA, the passenger PB, the passenger PC, and the passenger PD may be referred to as a passenger P unless otherwise distinguished from one another. The smartphone 4A, the smartphone 4B, the smartphone 4C, and the smartphone 4D may be referred to as a smartphone 4 unless otherwise distinguished from one another.

The content control device 2 is connected to a network NW via a first base station BS1, and is communicably connected to a server device 5 (computer) via the network NW. The content control device 2 acquires a content CA from the server device 5. The network NW is, for example, the Internet.

The smartphone 4 is connected to the network NW via a second base station BS2, and is communicably connected to the server device 5 via the network NW. The smartphone 4 acquires a content CB from the server device 5.

The smartphone 4 corresponds to an example of an “information processing device”.

In the present embodiment, a case will be described in which the “information processing device” is the smartphone 4, but embodiments are not limited thereto. The “information processing device” may be, for example, a tablet computer. The “information processing device” may be, for example, a notebook personal computer. The “information processing device” may be, for example, a desktop personal computer.

The smartphone 4 includes a second control unit 41. The second control unit 41 controls an operation of the smartphone 4.

The second control unit 41 includes a second processor 42 and a second memory 43.

The second processor 42 is implemented by a central processing unit (CPU) or a micro processing unit (MPU). The second processor 42 may be implemented by a single processor or a plurality of processors. The second memory 43 is implemented by, for example, a non-volatile semiconductor memory, or a combination of a volatile semiconductor memory and a non-volatile semiconductor memory. The second memory 43 stores a second control program PG2.

The second control unit 41 includes a second content acquisition unit 421, a second content output unit 422, and an outside-vehicle history storage unit 431.

The second processor 42 executes the second control program PG2 stored in the second memory 43, thereby functioning as the second content acquisition unit 421 and the second content output unit 422. In addition, the second processor 42 executes the second control program PG2 stored in the second memory 43, thereby causing the second memory 43 to function as the outside-vehicle history storage unit 431.

The outside-vehicle history storage unit 431 stores an outside-vehicle output history HQ. The outside-vehicle output history HQ is stored in the outside-vehicle history storage unit 431 by the second content output unit 422.

The outside-vehicle output history HQ classifies the content CB output outside the vehicle 200 by the passenger P according to each type TY of the content CB, and stores the number of occurrences of output NT of the content CB for each of the types TY of the content CB. In other words, the outside-vehicle output history HQ stores the number of occurrences of output NT of the content CB in association with the type TY of the content CB.

The type TY of the content CB will be described with reference to FIG. 2.

The outside-vehicle output history HQ is classified according to each outside-vehicle environment information indicating the environment in which the passenger P outputs the content CB outside the vehicle 200, and stores the number of occurrences of output NT of the content CB for each type TY of the content CB.

The “outside-vehicle environment information” includes home, train, motorcycle, and walking, for example.

That “outside-vehicle environment information” is “home” indicates that the passenger P outputs the content CB at home. That “outside-vehicle environment information” is “train” indicates that the passenger P outputs the content CB in the train. That “outside-vehicle environment information” is “motorcycle” indicates that the passenger P outputs the content CB while riding the motorcycle. That “outside-vehicle environment information” is “walking” indicates that the passenger P outputs the content CB while moving on foot.

The second content acquisition unit 421 acquires the content CB from the server device 5 based on a user's operation received via a touch panel (not illustrated).

The second content output unit 422 outputs the content CB acquired by the second content acquisition unit 421 to a touch panel (not illustrated) and a speaker (not illustrated). When the output of the content CB is completed, the second content output unit 422 determines the type TY of the content CB completed to be output, and updates the outside-vehicle output history HQ stored in the outside-vehicle history storage unit 431. The second content output unit 422 increases the number of occurrences of output NT of the content corresponding to the type TY, out of the outside-vehicle output history HQ by “1”.

The content control device 2 acquires, from the smartphone 4, the outside-vehicle output history HQ stored in the outside-vehicle history storage unit 431.

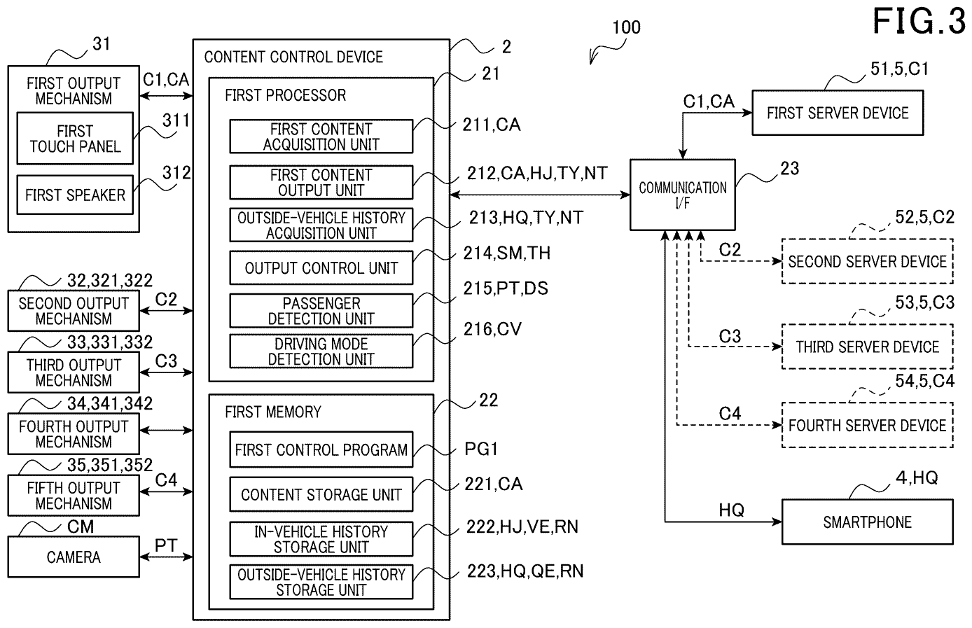

The outside-vehicle output history HQ will be further described with reference to FIG. 3.

### 2. CONFIGURATION OF VEHICLE

Next, a configuration of the vehicle 200 mounted with the content control device 2 will be described with reference to FIG. 2. FIG. 2 is a plan view illustrating an example of the vehicle 200 mounted with the content control device 2 according to the present embodiment.

FIG. 2 illustrates an X-axis, a Y-axis, and a Z-axis that are orthogonal to each other. The X-axis and the Y-axis are parallel to a horizontal direction. The Z-axis is parallel to a vertical direction. The X-axis is parallel to a left-right direction of the vehicle 200. The Y-axis is parallel to a front-rear direction of the vehicle 200. A positive direction of the X-axis indicates a right direction of the vehicle. A positive direction of the Y-axis indicates a front direction of the vehicle. A positive direction of the Z-axis indicates an upward direction of the vehicle.

FIG. 2 illustrates a plan view of the vehicle 200 being in a state where a roof is removed.

As illustrated in FIG. 2, the vehicle 200 includes a seat 1, a content control device 2, an output mechanism 3, and a camera CM.

In the present embodiment, the seat 1 is composed of a first seat 11, a second seat 12, a third seat 13, a fourth seat 14, and a fifth seat 15.

The first seat 11 and the second seat 12 are arranged at a front part in the vehicle 200. The first seat 11 and the second seat 12 constitute front seats. The third seat 13, the fourth seat 14, and the fifth seat 15 are arranged behind the first seat 11 and the second seat 12 in the vehicle 200. The third seat 13, the fourth seat 14, and the fifth seat 15 constitute back seats.

The first seat 11 is a driver's seat arranged on a right side in the front seats. The passenger PA is seated on the first seat 11. The passenger PA is a driver. In the present embodiment, the driver is included in the passenger P.

The second seat 12 is a passenger seat arranged to a left of the first seat 11. In the present embodiment, the passenger PB is seated on the second seat 12.

The third seat 13 is a seat arranged on the right side in the back seats. In the present embodiment, the passenger PC is seated on the third seat 13.

The fourth seat 14 is a seat arranged in a center part in the back seats. In the present embodiment, the passenger P is not seated on the fourth seat 14.

The fifth seat 15 is a seat arranged on the left side in the back seats. In the present embodiment, the passenger PD is seated on the fifth seat 15.

In the following description, the first seat 11, the second seat 12, the third seat 13, the fourth seat 14, and the fifth seat 15 may be referred to as a seat 1 unless otherwise distinguished from one another.

The output mechanism 3 is composed of a first output mechanism 31, a second output mechanism 32, a third output mechanism 33, a fourth output mechanism 34, and a fifth output mechanism 35.

As described with reference to FIG. 3, the first output mechanism 31 includes a first touch panel 311 and a first speaker 312. The second output mechanism 32 includes a second touch panel 321 and a second speaker 322. The third output mechanism 33 includes a third touch panel 331 and a third speaker 332. The fourth output mechanism 34 includes a fourth touch panel 341 and a fourth speaker 342. The fifth output mechanism 35 includes a fifth touch panel 351 and a fifth speaker 352.

The first output mechanism 31 is arranged on a dashboard in front of the first seat 11, for example. The first touch panel 311 of the first output mechanism 31 is arranged such that a display screen thereof faces the passenger PA. In other words, the first touch panel 311 of the first output mechanism 31 is arranged such that the display screen faces rearward.

The first touch panel 311 and the first speaker 312 output a content C1 according to instructions from the content control device 2. The first touch panel 311 displays an image in the content C1. The first speaker 312 outputs voice in the content C1. The content C1 corresponds to an example of a content CA illustrated in FIG. 1.

In the present embodiment, since the passenger PA is the driver, the first touch panel 311 is prohibited from displaying images when the passenger PA is driving.

The second output mechanism 32 is arranged on a dashboard in front of the second seat 12, for example. The second touch panel 321 of the second output mechanism 32 is arranged such that a display screen thereof faces the passenger PB seated on the second seat 12. In other words, the second touch panel 321 of the second output mechanism 32 is arranged such that the display screen faces rearward.

The second touch panel 321 and the second speaker 322 output a content C2 according to instructions from the content control device 2. The second touch panel 321 and the second speaker 322 output a content C2. The second touch panel 321 displays an image in the content C2. The second speaker 322 outputs voice in the content C2. The content C2 corresponds to an example of the content CA illustrated in FIG. 1.

The third output mechanism 33 is arranged, for example, on a back surface of the first seat 11 in front of the third seat 13, that is, on the back surface of the backrest of the first seat 11. The third touch panel 331 of the third output mechanism 33 is arranged such that a display screen thereof faces the passenger PC. In other words, the third touch panel 331 of the third output mechanism 33 is arranged such that the display screen faces rearward.

The third touch panel 331 and the third speaker 332 output a content C3 according to instructions from the content control device 2. The third touch panel 331 displays an image in the content C3. The third speaker 332 outputs voice in the content C3. The content C3 corresponds to the content CA illustrated in FIG. 1.

The fourth output mechanism 34 is arranged, for example, on a back surface of the first seat 11 and the second seat 12 in front of the fourth seat 14. The fourth touch panel 341 of the fourth output mechanism 34 is arranged such that a display screen thereof faces the passenger P seated on the fourth seat 14. In other words, the fourth touch panel 341 of the fourth output mechanism 34 is arranged such that the display screen faces rearward.

The fourth touch panel 341 and the fourth speaker 342 output a content C according to instructions from the content control device 2. The fourth touch panel 341 displays an image in the content C. The fourth speaker 342 outputs voice in the content C. In the present embodiment, since the passenger P is not seated on the fourth seat 14, the fourth touch panel 341 and the fourth speaker 342 do not output the content C.

The fifth output mechanism 35 is arranged, for example, on a back surface of the second seat 12 in front of the fifth seat 15. The fifth touch panel 351 of the fifth output mechanism 35 is arranged such that a display screen thereof faces the passenger PD. In other words, the fifth touch panel 351 of the fifth output mechanism 35 is arranged such that the display screen faces rearward.

The fifth touch panel 351 and the fifth speaker 352 output a content C4 according to instructions from the content control device 2. The fifth touch panel 351 displays an image in the content C4. The fifth speaker 352 outputs voice in the content C4.

The content control device 2 acquires the content C1 from a first server device 51 illustrated in FIG. 3. The content control device 2 outputs the content C1 to the first touch panel 311 and the first speaker 312 of the first output mechanism 31.

The content control device 2 acquires the content C2 from a second server device 52 illustrated in FIG. 3. The content control device 2 outputs the content C2 to the second touch panel 321 and the second speaker 322 of the second output mechanism 32.

The content control device 2 acquires the content C3 from a third server device 53 illustrated in FIG. 3. The content control device 2 outputs the content C3 to the third touch panel 331 and the third speaker 332 of the third output mechanism 33.

The content control device 2 acquires the content C4 from a fourth server device 54 illustrated in FIG. 3. The content control device 2 outputs the content C4 to the fifth touch panel 351 and the fifth speaker 352 of the fifth output mechanism 35.

The content C1, the content C2, the content C3, and the content C4 are, for example, contents C that are different from each other.

Each of the content C1, the content C2, the content C3, and the content C4 corresponds to an example of the content CA illustrated in FIG. 1.

A configuration of the content control device 2 will be further described with reference to FIG. 3.

In the present embodiment, a case will be described in which the passengers P are four person, that is, the passenger PA, the passenger PB, the passenger PC, and the passenger PD, but the embodiment is not limited thereto. For example, the passengers P may be three or less persons. Furthermore, for example, the passengers P may be five or more persons.

The camera CM is arranged, for example, an interior side of the roof (not illustrated), that is, in front of a lower surface. The camera CM includes an image sensor such as a charge coupled device (CCD), and generates an image PT including all of the passengers P, who are in the vehicle 200, according to instructions from the content control device 2. The camera CM outputs the generated image PT to the content control device 2.

In the present embodiment, the camera CM generates an image PT including the passengers PA seated on the first seat 11, the passengers PB seated on the second seat 12, the passengers PC seated on the third seat 13, and the passengers PD seated on the fifth seat 15, according to instructions from the content control device 2.

In the present embodiment, a case has been described in which one camera CM generates the image PT, but embodiments are not limited thereto. A plurality of cameras CM may generate the image PT. For example, a camera CM may be arranged in each of the first output mechanism 31, the second output mechanism 32, the third output mechanism 33, the fourth output mechanism 34, and the fifth output mechanism 35.

### 3. CONFIGURATION OF CONTENT CONTROL DEVICE

Next, the configuration of the content control device 2 according to the present embodiment will be described with reference to FIG. 3. FIG. 3 is a diagram illustrating an example of the configuration of the content control device 2 according to the present embodiment.

As illustrated in FIG. 3, the content control device 2 is communicably connected to the first output mechanism 31, the second output mechanism 32, the third output mechanism 33, the fourth output mechanism 34, the fifth output mechanism 35, and the camera CM.

The first output mechanism 31 includes the first touch panel 311 and the first speaker 312.

The first touch panel 311 includes a display such as a liquid crystal display (LCD) and a touch sensor. The display displays various images according to instructions from content control device 2. The touch sensor is formed integrally with the display screen of the display, and detects a touch operation of the passenger P. The touch sensor outputs a signal indicating the detected touch operation to the content control device 2.

The first speaker 312 outputs various types of voice according to instructions from the content control device 2.

The second output mechanism 32 includes a second touch panel 321 and a second speaker 322. The third output mechanism 33 includes a third touch panel 331 and a third speaker 332. The fourth output mechanism 34 includes a fourth touch panel 341 and a fourth speaker 342. The fifth output mechanism 35 includes a fifth touch panel 351 and a fifth speaker 352.

Each of the second touch panel 321, the third touch panel 331, the fourth touch panel 341, and the fifth touch panel 351 has substantially the same configuration as the first touch panel 311.

In the following description, the first touch panel 311, the second touch panel 321, the third touch panel 331, the fourth touch panel 341, and the fifth touch panel 351 may be referred to as a “touch panel TP” unless otherwise distinguished from one another.

Each of the second speaker 322, the third speaker 332, the fourth speaker 342, and the fifth speaker 352 has substantially the same configuration as the first speaker 312.

In the following description, the first speaker 312, the second speaker 322, the third speaker 332, the fourth speaker 342, and the fifth speaker 352 may be referred to as a “speaker SP” unless otherwise distinguished from one another.

The camera CM captures an image PT including all of the passengers P, who are in the vehicle 200, according to instructions from the content control device 2. The camera CM outputs the captured image PT to the content control device 2.

The content control device 2 is implemented by an electronic control unit (ECU), for example. The content control device 2 includes a first processor 21, a first memory 22, and a communication interface 23.

The communication interface 23 includes an antenna, a connector, and an interface circuit, and is connected to the first processor 21. The communication interface 23 is an interface for communicating with the server device 5. The communication interface 23 is an interface for wirelessly communicating with the server device 5 according to the 4G standard, the 5G standard, or the Wi-Fi (registered trademark) standard.

The communication interface 23 communicates with the server device 5 via the first base station BS1 and the network NW which are illustrated in FIG. 1.

The server device 5 includes, for example, the first server device 51, the second server device 52, the third server device 53, and the fourth server device 54.

The first server device 51 transmits the content C1 to the content control device 2 in response to a request from the content control device 2. The second server device 52 transmits the content C2 to the content control device 2 in response to a request from the content control device 2. The third server device 53 transmits the content C3 to the content control device 2 in response to a request from the content control device 2. The fourth server device 54 transmits the content C4 to the content control device 2 in response to a request from the content control device 2.

The first server device 51, the second server device 52, the third server device 53, and the fourth server device 54 have substantially the same configuration. The first server device 51, the second server device 52, the third server device 53, and the fourth server device 54 may be referred to as a server device 5 in the following description, unless otherwise distinguished from one another.

In the description above, a case has been described in which the content control device 2 acquires four contents CA, that is, the content C1, the content C2, the content C3, and the content C4, but the content control device 2 is not limited thereto. The content control device 2 only needs to acquire at least one content CA. The content control device 2 may acquire, for example, one content CA. For example, the content control device 2 may acquire, for example, two contents CA. For example, the content control device 2 may acquire, for example, three contents CA. For example, the content control device 2 may acquire, for example, five or more contents CA.

In the following description, for convenience, a case will be mainly described in which the content control device 2 acquires one content CA, for example, the content C1. The content C1 is acquired from the first server device 51 and output to the first output mechanism 31 based on instructions from the passenger PA.

The first processor 21 is implemented by a CPU or an MPU. The first processor 21 may be implemented by a single processor or a plurality of processors. The first memory 22 is implemented by, for example, a non-volatile semiconductor memory, or a combination of a volatile semiconductor memory and a non-volatile semiconductor memory. The first memory 22 stores a first control program PG1.

The first control program PG1 corresponds to an example of a “content control program”.

The content control device 2 includes a first content acquisition unit 211, a first content output unit 212, an outside-vehicle history acquisition unit 213, an output control unit 214, a passenger detection unit 215, a driving mode detection unit 216, a content storage unit 221, an in-vehicle history storage unit 222, and an outside-vehicle history storage unit 223.

The first processor 21 executes the first control program PG1 stored in the first memory 22 to function as the first content acquisition unit 211, the first content output unit 212, the outside-vehicle history acquisition unit 213, the output control unit 214, the passenger detection unit 215, and the driving mode detection unit 216. In addition, the first processor 21 executes the first control program PG1 stored in the first memory 22 to cause the first memory 22 to function as the content storage unit 221, the in-vehicle history storage unit 222, and the outside-vehicle history storage unit 223.

The content storage unit 221 stores the content CA acquired by the first content acquisition unit 211. The content CA is stored in the content storage unit 221 by the first content acquisition unit 211.

The in-vehicle history storage unit 222 stores an in-vehicle output history HJ. The in-vehicle output history HJ classifies the content CA output by the first content output unit 212 according to each type TY of content CA, and stores the number of occurrences of output NT of the content CA for each of the types TY of the content CA in association with the passenger PA. In other words, the in-vehicle output history HJ stores the type TY of the content CA and the number of occurrences of output NT of the content CA in association with each other.

The in-vehicle output history HJ is stored in the in-vehicle history storage unit 222 by the first content output unit 212.

The in-vehicle history storage unit 222 corresponds to an example of a “history storage unit”.

The type TY of the content CA includes at least one of a website that delivers the content and a genre of the content.

The website, which delivers the content CA, corresponds to an application that delivers the content CA. A connection is made to the website that delivers the content CA by execution of the application that delivers the content CA.

The genre of the content CA includes, for example, J-POP, rock music, classical music, and jazz music when the content CA is a music content.

In the following description, a case will be described in which the type TY of the content CA is the genre of the content CA, for example.

In the present embodiment, a case will be described in which the type TY of the content CA is the genre of the content CA, but embodiments are not limited thereto. The type TY of the content CA may include at least one of a website that delivers the content CA and a genre of the content CA. The type TY of the content CA may be, for example, a website that delivers the content CA and a genre of the content CA. Furthermore, the type TY of the content CA may be, for example, a website that delivers the content CA.

The first content acquisition unit 211 is communicably connected to the first server device 51 via the communication interface 23, and acquires the content CA from the server device 5. For example, based on instructions from the passenger PA, the first content acquisition unit 211 is communicably connected to the first server device 51 via the communication interface 23, and acquires the content CA from the first server device 5. The first content acquisition unit 211 causes the content storage unit 221 to store the content CA acquired from the first server device 51.

The first content acquisition unit 211 constitutes a part of the “content output unit”.

The first server device 51 corresponds to an example of the server device 5.

Here, an example of processing of the first content acquisition unit 211 will be described.

First, the first content acquisition unit 211 displays a plurality of icons on the touch panel TP, for example. The icons correspond to websites that provide the contents CA. The website corresponds to the first server device 51 that provides the content CA. For example, the passenger PA performs a touch operation to select one icon from the plurality of icons displayed on the touch panel TP. The first content acquisition unit 211 is communicably connected to the first server device 51 corresponding to the selected one icon.

Next, the passenger PA inputs account information via the touch panel TP. The first content acquisition unit 211 transmits the account information to the first server device 51, which is communicably connected, and logs in to the first server device 51. The first content acquisition unit 211 may transmit password information in addition to the account information.

Next, the first content acquisition unit 211 displays icons corresponding to the plurality of contents C, which are provided by the first server device 51, on the touch panel TP. The passenger PA performs a touch operation to select an icon corresponding to one content CA, which is wished to view, from the plurality of contents C provided by the first server device 51. The first content acquisition unit 211 downloads the selected one content CA from the first server device 51. Then, the first content acquisition unit 211 causes the content storage unit 221 to store the content CA acquired from the first server device 51.

The first content output unit 212 outputs the content CA to the passenger PA seated on the seat 11 in the vehicle 200. The first content output unit 212 causes the first output mechanism 31 to output the content CA acquired by the first content acquisition unit 211.

Furthermore, when the output of the content CA is completed, the first content output unit 212 determines the type TY of the content CA. For example, when the first content acquisition unit 211 acquires the content CA from the server device 5, the first content acquisition unit 211 acquires information indicating the type TY of the content CA from the server device 5. Then, the first content output unit 212 determines the type TY of the content CA based on the information indicating the type TY of the content CA acquired by the first content acquisition unit 211.

In addition, when the output of the content CA is completed, the first content output unit 212 updates the in-vehicle output history HJ stored in the in-vehicle history storage unit 222 and corresponding to the passenger PA. The first content output unit 212 increases the number of occurrences of output NT of the content CA corresponding to the type TY of the content CA, out of the in-vehicle output history HJ corresponding to the passenger PA by “1”.

Every time the output of the content CA is completed, the first content output unit 212 updates the in-vehicle output history HJ stored in the in-vehicle history storage unit 222 and corresponding to the passenger PA who views the content CA. In this way, the in-vehicle output history HJ corresponding to the passenger PA is stored in the in-vehicle history storage unit 222 by the first content output unit 212.

The first content output unit 212 constitutes a part of the “content output unit”.

In other words, the first content acquisition unit 211 and the first content output unit 212 correspond to an example of the “content output unit”.

The outside-vehicle history acquisition unit 213 acquires the outside-vehicle output history HQ corresponding to the passenger PA from the smartphone 4A owned by the passenger PA. The outside-vehicle output history HQ classifies the content CB output outside the vehicle 200 by the passenger PA according to each type TY of the content CB, and stores the number of occurrences of output NT of the content CB for each of the types TY of the content CB. In other words, the outside-vehicle output history HQ stores the number of occurrences of output NT of the content CB in association with the type TY of the content CB.

The type TY of the content CB corresponds to the type TY of the content CA. For example, the type TY of the content CB is the genre of the content CB.

The output control unit 214 calculates a similarity SM indicating the degree of similarity between the in-vehicle output history HJ of the passenger PA and the outside-vehicle output history HQ of the passenger PA, and controls the content CA output by the first content output unit 212 according to the similarity SM.

The similarity SM is calculated as follows, with “10” being the perfect score.

First, for each of the in-vehicle output history HJ and the outside-vehicle output history HQ, the output control unit 214 assigns a ranking RN to each of the type TY of the content CB based on the number of occurrences of output NT of the content CB for each of the types TY of the content CB. The ranking RN indicates a ranking RN with the large number of occurrences of output NT.

Next, the output control unit 214 determines, for each ranking RN, whether the type TY of the content CA in the in-vehicle output history HJ matches the type TY of the content CB in the outside-vehicle output history HQ.

Then, when the types TY corresponding to the ranking RN being “No. 1” match each other, the output control unit 214 adds the similarity SM by “4”. When the types TY corresponding to the ranking RN being “No. 2” match each other, the output control unit 214 adds the similarity SM by “3”. When the types TY corresponding to the ranking RN being “No. 3” match each other, the output control unit 214 adds the similarity SM by “2”. When the types TY corresponding to the ranking RN being “No. 4” match each other, the output control unit 214 adds the similarity SM by “1”.

When the types TY of the content C do not match each other for each ranking RN, there is no adding of the similarity SM.

In this way, the output control unit 214 calculates the similarity SM.

Then, when the similarity SM is equal to or more than a threshold TH, the output control unit 214 determines that the in-vehicle output history HJ and the outside-vehicle output history HQ are similar to each other. When the similarity SM is less than the threshold TH, the output control unit 214 determines that the in-vehicle output history HJ and the outside-vehicle output history HQ are not similar to each other.

The threshold TH is, for example, “6”.

The threshold TH corresponds to an example of a “preset threshold”.

When the similarity SM is equal to or more than the threshold TH, the output control unit 214 controls the content to be output by the first content output unit 212, based on the in-vehicle output history HJ and the outside-vehicle output history HQ. The output control unit 214 controls the first content output unit 212 to preferentially output the content C of the type TY with the large number of occurrences of output NT in the in-vehicle output history HJ and the outside-vehicle output history HQ, for example.

When the similarity SM is less than the threshold TH, the output control unit 214 controls the content to be output by the first content output unit 212, based on the in-vehicle output history HJ. The output control unit 214 controls the first content output unit 212 to preferentially output the content C of the type TY with the large number of occurrences of output NT in the in-vehicle output history HJ, for example.

The passenger detection unit 215 causes the camera CM to capture an image PT and acquires the captured image PT.

In addition, the passenger detection unit 215 performs image processing on the image PT, and detects the passenger P who is in the vehicle 200. The passenger detection unit 215 detects a seating position of the passenger PA. In other words, the passenger detection unit 215 detects the seat 1 on which the passenger PA is seated. Furthermore, the passenger detection unit 215 detects the number of passengers P who are in the vehicle 200.

Furthermore, the passenger detection unit 215 detects passenger identification information DS, which is information for identifying the passenger P in the vehicle 200. The passengers P include, for example, the passenger PA, the passenger PB, the passenger PC, and the passenger PD.

The driving mode detection unit 216 detects a driving mode CV. The driving mode detection unit 216, for example, communicates with an ECU (not illustrated) that controls the driving mode CV of the vehicle 200, and acquires the driving mode CV from the ECU (not illustrated), thereby acquiring the driving mode CV of the vehicle 200. The driving mode CV of the vehicle 200 indicates, for example, whether the vehicle 200 is being driven by a driver or is being in automatic driving.

In the present embodiment, the “automatic driving” means so-called automatic driving of “level 3” or higher as defined by society of automotive engineers (SAE).

### 4. SPECIFIC EXAMPLE OF PROCESSING OF OUTPUT CONTROL UNIT

Next, a specific example of processing of the output control unit 214 will be described with reference to FIGS. 3 to 8.

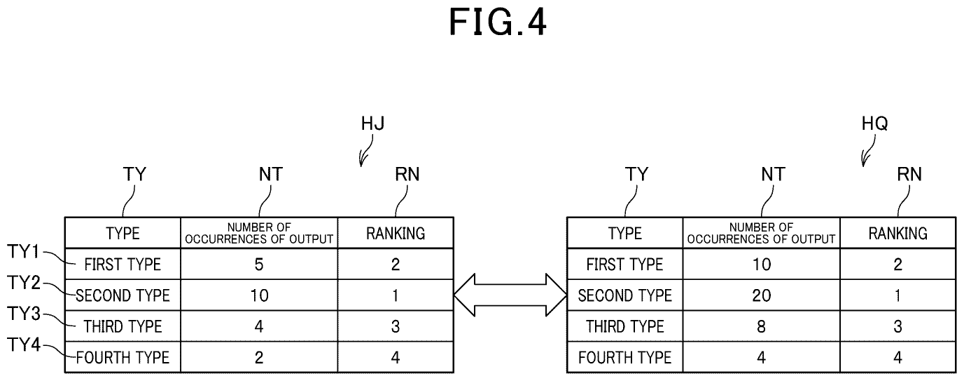

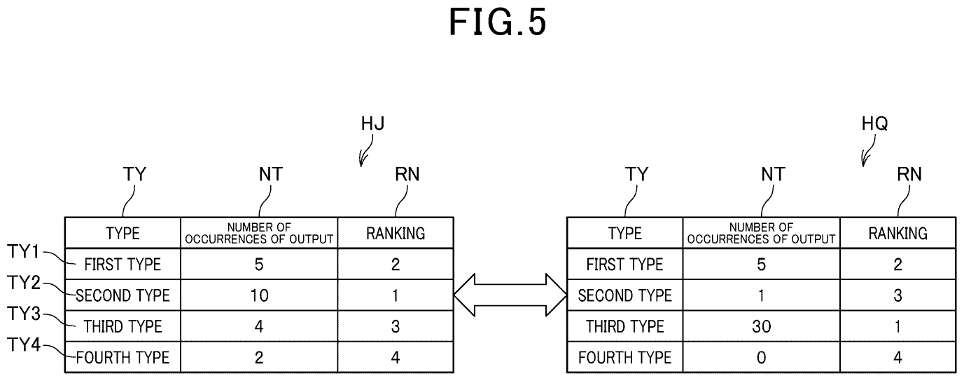

First, the similarity SM will be further described with reference to FIGS. 4 and 5.

FIG. 4 is a table illustrating an example of a case where the in-vehicle output history HJ and the outside-vehicle output history HQ are similar to each other. FIG. 5 is a table illustrating an example of a case where the in-vehicle output history HJ and the outside-vehicle output history HQ are not similar to each other.

In FIG. 4, a left side shows an example of the in-vehicle output history HJ, and a right side shows an example of the outside-vehicle output history HQ.

In each of the in-vehicle output history HJ and the outside-vehicle output history HQ, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

In the in-vehicle output history HJ, for example, the number of occurrences of output NT of the content CA of the first type TY1 is “5 times”, the number of occurrences of output NT of the content CA of the second type TY2 is “10 times”, the number of occurrences of output NT of the content CA of the third type TY3 is “4 times”, and the number of occurrences of output NT of the content CA of the fourth type TY4 is “2 times”.

Therefore, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

In the outside-vehicle output history HQ, for example, the number of occurrences of output NT of the content CB of the first type TY1 is “10 times”, the number of occurrences of output NT of the content CB of the second type TY2 is “20 times”, the number of occurrences of output NT of the content CB of the third type TY3 is “8 times”, and the number of occurrences of output NT of the content CB of the fourth type TY4 is “4 times”.

Therefore, the type TY of the content CB with the ranking RN being “No. 1” is the second type TY2, the type TY of the content CB with the ranking RN being “No. 2” is the first type TY1, the type TY of the content CB with the ranking RN being “No. 3” is the third type TY3, and the type TY of the content CB with the ranking RN being “No. 4” is the fourth type TY4.

In this case, in the in-vehicle output history HJ and the outside-vehicle output history HQ, the types TY corresponding to the ranking RN being “No. 1” are the second types TY2, respectively, which are match. In addition, the types TY corresponding to the ranking RN being “No. 2” are the first types TY1, respectively, which are match. The types TY corresponding to the ranking RN being “No. 4” are the fourth types TY4, respectively, which are match.

Therefore, the output control unit 214 calculates the similarity SM to be “10 (=4+3+2+1)” and determines, from the fact that the similarity SM is equal to or more than the threshold TH, that the in-vehicle output history HJ and the outside-vehicle output history HQ are similar to each other. In this case, the output control unit 214 controls the first content output unit 212 to preferentially output the content C of the type TY with the large number of occurrences of output NT in the in-vehicle output history HJ and the outside-vehicle output history HQ, for example.

In FIG. 5, a left side shows an example of the in-vehicle output history HJ, and a right side shows an example of the outside-vehicle output history HQ.

In each of the in-vehicle output history HJ and the outside-vehicle output history HQ, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

The in-vehicle output history HJ illustrated in FIG. 5 is the same as the in-vehicle output history HJ illustrated in FIG. 4.

In other words, in the in-vehicle output history HJ, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

In the outside-vehicle output history HQ, for example, the number of occurrences of output NT of the content CB of the first type TY1 is “5 times”, the number of occurrences of output NT of the content CB of the second type TY2 is “1 time”, the number of occurrences of output NT of the content CB of the third type TY3 is “30 times”, and the number of occurrences of output NT of the content CB of the fourth type TY4 is “0 times”.

Therefore, the type TY of the content CB with the ranking RN being “No. 1” is the third type TY3, the type TY of the content CB with the ranking RN being “No. 2” is the first type TY1, the type TY of the content CB with the ranking RN being “No. 3” is the second type TY2, and the type TY of the content CB with the ranking RN being “No. 4” is the fourth type TY4.

In this case, the type TY corresponding to the ranking RN being “No. 1” is the second types TY2 in the in-vehicle output history HJ, and is the third type TY3 in the outside-vehicle output history HQ, whereby the types do not match. In the in-vehicle output history HJ and the outside-vehicle output history HQ, the types TY corresponding to the ranking RN being “No. 2” are the first types TY1, respectively, which are match. The type TY corresponding to the ranking RN being “No. 3” is the third types TY3 in the in-vehicle output history HJ, and is the second type TY2 in the outside-vehicle output history HQ, whereby the types do not match. The types TY corresponding to the ranking RN being “No. 4” are the fourth types TY4, respectively, which are match.

Therefore, the output control unit 214 calculates the similarity SM to be “4 (=3+1)” and determines, from the fact that the similarity SM is less than the threshold TH, that the in-vehicle output history HJ and the outside-vehicle output history HQ are not similar to each other. In this case, the output control unit 214 controls the first content output unit 212 to preferentially output the content C of the type TY with the large number of occurrences of output NT in the in-vehicle output history HJ, for example.

Returning to FIG. 3 again, the configuration of the content control device 2 will be described.

When the similarity SM is equal to or more than the threshold TH, if the outside-vehicle output history HQ involves the content CB being in the middle of output by the passenger PA outside the vehicle 200 before the passenger PA enters the vehicle 200, the output control unit 214 executes the following processing. In other words, the output control unit 214 controls the first content acquisition unit 211 and the first content output unit 212 to output the content C being in the middle of output from the middle of output.

In this case, when acquiring the outside-vehicle output history HQ from the smartphone 4A, if there is the content CB being in the middle of output, the outside-vehicle history acquisition unit 213 acquires information indicating that there is the content CB being in the middle of output as the outside-vehicle output history HQ.

The first content acquisition unit 211 acquires a content CA corresponding to the content CB which is in the middle of output on the smartphone 4A by the passenger PA. Then, the first content output unit 212 outputs the acquired content CA from the middle of output.

Thus, the passenger PA can continue viewing the content CA corresponding to the content CB, which is being output on the smartphone 4A before entering the vehicle 200, from the middle of output after entering the vehicle 200. Therefore, the convenience for the passenger PA can be improved.

When the similarity SM is less than the threshold TH, the output control unit 214 controls the content CA output by the first content output unit 212 so as to preferentially output the type TY of the content CB whose number of occurrences of output NT is equal to or less than a predetermined number of times in the outside-vehicle output history HQ, from among the types TY of the content CA involved in the in-vehicle output history HJ. The predetermined number of times is, for example, “four times”.

The predetermined number of times may be set to, for example, an average number of times from the number of occurrences of output NT corresponding to each of the types TY of the content C in the outside-vehicle output history HQ.

In addition, the predetermined number of times may be set to a predetermined percentage of the number of occurrences of output NT corresponding to the type TY of the content C with the ranking being “No. 1” in the outside-vehicle output history HQ, for example. The predetermined percentage may be, for example, 30%.

In the present embodiment, the output control unit 214 preferentially outputs the type TY of the content CB whose number of occurrences of output NT is equal to or less than the predetermined number of times in the outside-vehicle output history HQ, from among the types TY of the content CA involved in the in-vehicle output history HJ, but embodiments are not limited thereto. For example, the output control unit 214 may preferentially output the type TY of the content CB with a predetermined ranking RN or less in the outside-vehicle output history HQ, from among the types TY of the content CA involved in the in-vehicle output history HJ. The predetermined ranking RN is, for example, “No. 3”.

When the similarity SM is less than the threshold TH, the output control unit 214 determines that the in-vehicle output history HJ and the outside-vehicle output history HQ are not similar to each other. When the in-vehicle output history HJ and the outside-vehicle output history HQ are not similar to each other as described above, there is a possibility that the passenger PA selectively uses the type TY of the content CA to be output when being in the vehicle 200 and the type TY of the content CB to be viewed on the smartphone 4A outside the vehicle 200.

Therefore, in order to control the content CA to be output by the first content output unit 212 so as to preferentially output the type TY of the content CB whose number of occurrences of output NT is equal to or less than the predetermined number of times in the outside-vehicle output history HQ, from among the types TY of the content CA involved in the in-vehicle output history HJ, the content CA can be output according to intention of the passenger PA when the passenger PA enters the vehicle 200.

Next, when the similarity SM is less than the threshold TH, the processing of the output control unit 214 will be described.

When there are a plurality of types TY of the content CB whose number of occurrences of output NT is equal to or less than the predetermined number of times in the outside-vehicle output history HQ, from among the types TY of the content CA involved in the in-vehicle output history HJ and when the plurality of types TY of the content CB include a type TY of the content CB whose number of occurrences of output NT is zero in the outside-vehicle output history HQ and a type TY of the content CB whose number of occurrences of output NT is one or more in the outside-vehicle output history HQ, the output control unit 214 executes the following processing. The predetermined number of times is, for example, “four times”.

In other words, the output control unit 214 controls the content CA output by the first content output unit 212 so as to output the type TY of the content CB whose number of occurrences of output NT is one or more in the outside-vehicle output history HQ in preference to the type of the content CB whose number of occurrences of output NT is zero in the outside-vehicle output history HQ.

For example, the above-described processing of the output control unit 214 will be described with respect to a case where the in-vehicle output history HJ and the outside-vehicle output history HQ are the in-vehicle output history HJ and the outside-vehicle output history HQ illustrated in FIG. 5. As illustrated with reference to FIG. 5, the similarity SM between the in-vehicle output history HJ and the outside-vehicle output history HQ illustrated in FIG. 5 is less than the threshold TH.

In the outside-vehicle output history HQ, the types TY of the content CB whose number of occurrences of output NT is equal to or less than the predetermined number of times are the second type TY2 and the fourth type TY4. The number of occurrences of output NT of the content CB corresponding to the second type TY2 is “1 time”, and the number of occurrences of output NT of the content CB corresponding to the fourth type TY4 is zero.

Therefore, in this case, the output control unit 214 controls the content CA output by the first content output unit 212 so as to output the second type TY2 in preference to the fourth type TY4.

The content CB whose number of occurrences of output NT is zero in the outside-vehicle output history HQ may not suit taste of the passenger PA, for example. Therefore, since the type TY of the content CB whose number of occurrences of output NT is one or more in the outside-vehicle output history HQ is output in preference to the type of the content CB whose number of occurrences of output NT is zero in the outside-vehicle output history HQ, the content suitable for the passenger PA can be output.

Furthermore, when the similarity SM is less than the threshold TH, if the outside-vehicle output history HQ involves the content CB being in the middle of output by the passenger PA outside the vehicle 200 before the passenger PA enters the vehicle 200, the output control unit 214 executes the following processing.

In other words, the output control unit 214 controls the content CA output by the first content output unit 212 so as to output the content CB other than the content CB being in the middle of output based on the in-vehicle output history HJ.

When the similarity SM is less than the threshold TH, the output control unit 214 determines that the in-vehicle output history HJ and the outside-vehicle output history HQ are not similar to each other. When the in-vehicle output history HJ and the outside-vehicle output history HQ are not similar to each other as described above, there is a possibility that the passenger PA selectively uses the type TY of the content CA to be output when being in the vehicle 200 and the type TY of the content CB to be viewed on the smartphone 4A outside the vehicle 200.

Therefore, the output control unit 214 controls the content CA output by the first content output unit 212 so as to output the content CB other than the content CB being output based on the in-vehicle output history HJ, and thus the content CA can be output according to intention of the passenger PA.

In addition, when the similarity SM is less than the threshold TH, the output control unit 214 controls the content CA output by the first content output unit 212 so as to output the type TY of the content C whose number of occurrences of output NT is zero in the in-vehicle output history HJ and the outside-vehicle output history HQ.

In this way, since the type TY of the content C whose number of occurrences of output NT is zero in the in-vehicle output history HJ and the outside-vehicle output history HQ is output, the content C is output that the passenger PA has never viewed before. Therefore, when the passenger PA wishes to view the content C that the passenger PA has never viewed before in the vehicle 200, the content CA can be output that the passenger PA wishes to view.

When the similarity SM is less than the threshold TH, the following processing is executed.

The in-vehicle history storage unit 222 further classifies the content C output by the first content output unit 212 as, for example, the in-vehicle output history HJ according to each vehicle environment information VE including passenger information that is information regarding the passenger P of the vehicle 200 that the passenger PA is in, and stores the number of occurrences of output NT of the content CA for each vehicle environment information VE in association with the passenger PA.

The vehicle environment information VE includes, for example, the seating position of the passenger PA, the number of passengers P in the vehicle 200, the passenger identification information DS that is information for identifying the passenger P in the vehicle 200, and the driving mode CV indicating whether the vehicle 200 is being driven by a driver or is being in automatic driving. The passengers P include, for example, the passenger PA, the passenger PB, the passenger PC, and the passenger PD.

In this case, the output control unit 214 calculates a similarity SM indicating the degree of similarity between the in-vehicle output history HJ corresponding to the vehicle environment information VE of the vehicle 200 that the passenger PA is in and the outside-vehicle output history HQ, for example, and controls the content CA output by the first content output unit 212 according to the similarity SM.

In this way, the similarity SM indicating the degree of similarity between the in-vehicle output history HJ corresponding to the vehicle environment information VE of the vehicle 200 that the passenger PA is in and the outside-vehicle output history HQ is calculated, and the content CA output by the first content output unit 212 is controlled according to the similarity SM, whereby the content CA suitable for the passenger PA can be output.

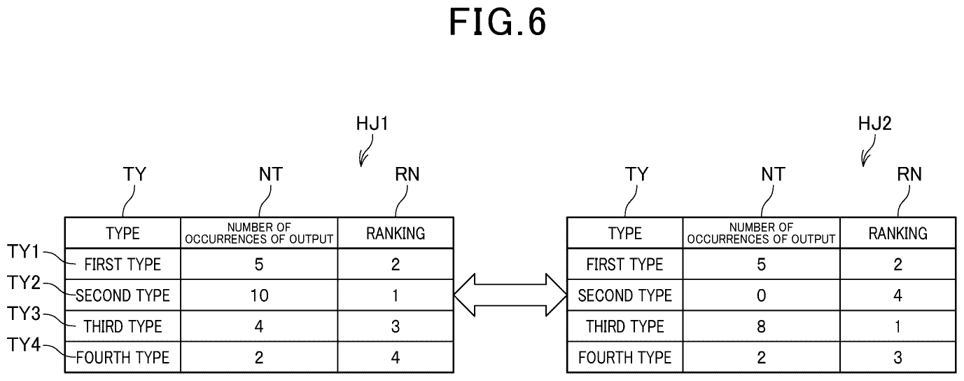

Next, a case will be described with reference to FIG. 6 in which the vehicle environment information VE includes the seating position of the passenger PA. FIG. 6 is a table illustrating an example of an in-vehicle output history HJ1 when the passenger PA is seated on the driver's seat (=seat 11) and an in-vehicle output history HJ2 when the passenger PA is seated on the passenger seat (=seat 12).

The passenger detection unit 215 detects the seating position of the passenger PA. Here, the passenger detection unit 215 detects whether the passenger PA is seated on the seat 11 or the passenger PA is seated on the seat 12.

In addition, the vehicle environment information VE includes the seating position of the passenger PA detected by the passenger detection unit 215.

Then, the in-vehicle history storage unit 222 stores the in-vehicle output history HJ1 when the passenger PA is seated on the seat 11 and the in-vehicle output history HJ2 when the passenger PA is seated on the seat 12.

In FIG. 6, a left side shows an example of the in-vehicle output history HJ1, and a right side shows an example of the in-vehicle output history HJ2.

In each of the in-vehicle output history HJ1 and the in-vehicle output history HJ2, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

The in-vehicle output history HJ1 illustrated in FIG. 6 is the same as the in-vehicle output history HJ illustrated in FIGS. 4 and 5.

In other words, in the in-vehicle output history HJ1, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

In the in-vehicle output history HJ2, for example, the number of occurrences of output NT of the content CB of the first type TY1 is “5 times”, the number of occurrences of output NT of the content CB of the second type TY2 is “0 times”, the number of occurrences of output NT of the content CB of the third type TY3 is “8 times”, and the number of occurrences of output NT of the content CB of the fourth type TY4 is “2 times”.

Therefore, the type TY of the content CB with the ranking RN being “No. 1” is the third type TY3, the type TY of the content CB with the ranking RN being “No. 2” is the first type TY1, the type TY of the content CB with the ranking RN being “No. 3” is the fourth type TY4, and the type TY of the content CB with the ranking RN being “No. 4” is the second type TY2.

As described above, since the in-vehicle output history HJ1 and the in-vehicle output history HJ2 are different from each other, it is preferable that the in-vehicle history storage unit 222 stores the in-vehicle output history HJ1 when the passenger PA is seated on the seat 11 and the in-vehicle output history HJ2 when the passenger PA is seated on the seat 12.

In this case, the output control unit 214 calculates a similarity SM indicating the degree of similarity between the in-vehicle output history HJ corresponding to the seating position where the passenger PA is seated and the outside-vehicle output history HQ, and controls the content CA output by the first content output unit 212 according to the similarity SM.

In other words, when the passenger PA is seated on the seat 11, the output control unit 214 calculates a similarity SM indicating the degree of similarity between the in-vehicle output history HJ1 and the outside-vehicle output history HQ, and controls the content CA output by the first content output unit 212 according to the similarity SM. In addition, when the passenger PA is seated on the seat 12, the output control unit 214 calculates a similarity SM indicating the degree of similarity between the in-vehicle output history HJ2 and the outside-vehicle output history HQ, and controls the content CA output by the first content output unit 212 according to the similarity SM.

In this way, the output control unit 214 calculates the similarity SM indicating the degree of similarity between the in-vehicle output history HJ corresponding to the seating position where the passenger PA is seated and the outside-vehicle output history HQ, and controls the content CA output by the first content output unit 212 according to the similarity SM, whereby the content CA suitable for the passenger PA can be output according to the seating position where the passenger PA is seated.

Next, a case will be described with reference to FIG. 6 in which the vehicle environment information VE includes the number of passengers P in the vehicle 200. FIG. 6 is a table illustrating an example of an in-vehicle output history HJ1 when the passenger PA in the vehicle 200 alone and an in-vehicle output history HJ2 when the passenger PA is in the vehicle 200 together with any fellow passenger.

In other words, the in-vehicle output history HJ1 indicates the in-vehicle output history HJ of the passenger PA when the number of passengers is one, and the in-vehicle output history HJ2 indicates the in-vehicle output history HJ of the passenger PA when the number of passengers is many.

The passenger detection unit 215 detects the number of passengers P in the vehicle 200 that the passenger PA is in.

In addition, the vehicle environment information VE includes the number of passengers P detected by the passenger detection unit 215.

Then, the in-vehicle history storage unit 222 stores the in-vehicle output history HJ1 of the passenger PA when the number of passengers in the vehicle 200 that the passenger PA is in is one, and the in-vehicle output history HJ2 of the passenger PA when the number of passengers in the vehicle 200 that the passenger PA is in is many.

In FIG. 6, a left side shows an example of the in-vehicle output history HJ1, and a right side shows an example of the in-vehicle output history HJ2.

In each of the in-vehicle output history HJ1 and the in-vehicle output history HJ2, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

The in-vehicle output history HJ1 illustrated in FIG. 6 is the same as the in-vehicle output history HJ illustrated in FIGS. 4 and 5.

In other words, in the in-vehicle output history HJ1, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

In the in-vehicle output history HJ2, the type TY of the content CB with the ranking RN being “No. 1” is the third type TY3, the type TY of the content CB with the ranking RN being “No. 2” is the first type TY1, the type TY of the content CB with the ranking RN being “No. 3” is the fourth type TY4, and the type TY of the content CB with the ranking RN being “No. 4” is the second type TY2.

As described above, since the in-vehicle output history HJ1 and the in-vehicle output history HJ2 are different from each other, it is preferable that the in-vehicle history storage unit 222 stores the in-vehicle output history HJ1 of the passenger PA when the number of passengers in the vehicle 200 that the passenger PA is in is one, and the in-vehicle output history HJ2 of the passenger PA when the number of passengers in the vehicle 200 that the passenger PA is in is many.

In this case, when the number of passengers in the vehicle 200 that the passenger PA is in is one, the output control unit 214 calculates a similarity SM indicating the degree of similarity between the in-vehicle output history HJ1 and the outside-vehicle output history HQ, and controls the content CA output by the first content output unit 212 according to the similarity SM. In addition, when the number of passengers in the vehicle 200 that the passenger PA is in is many, the output control unit 214 calculates a similarity SM indicating the degree of similarity between the in-vehicle output history HJ2 and the outside-vehicle output history HQ, and controls the content CA output by the first content output unit 212 according to the similarity SM.

In this way, the output control unit 214 calculates the similarity SM indicating the degree of similarity between the in-vehicle output history HJ1 or the in-vehicle output history HJ2 and the outside-vehicle output history HQ depending on whether the number of passengers P in the vehicle 200 that the passenger PA is in is one or many, and controls the content CA output by the first content output unit 212 according to the similarity SM, whereby the content CA suitable for the passenger PA can be output depending on whether the number of passengers P in the vehicle 200 is one or many.

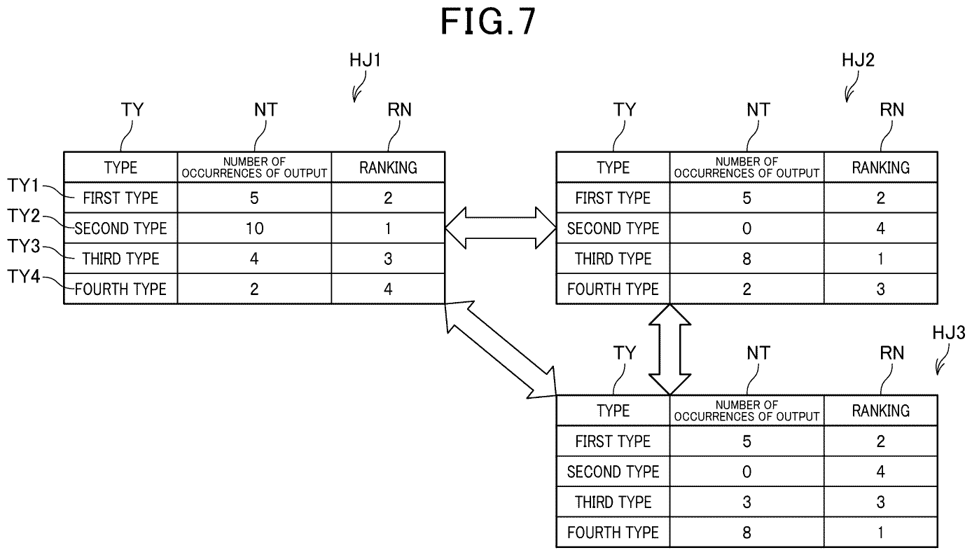

Next, a case will be described with reference to FIG. 7 in which the vehicle environment information VE includes identification information of any fellow passenger in the vehicle 200. Here, FIG. 7 is a table illustrating an example of an in-vehicle output history HJ1 when the passenger PA in the vehicle 200 alone, and an in-vehicle output history HJ2 and an in-vehicle output history HJ3 corresponding to the other passenger P when the number of passengers is two.

In other words, the in-vehicle output history HJ1 indicates the in-vehicle output history HJ of the passenger PA when the number of passengers is one, the in-vehicle output history HJ2 indicates the in-vehicle output history HJ of the passenger PA when the number of passengers is two and the other passenger P is the passenger PB, and the in-vehicle output history HJ3 indicates the in-vehicle output history HJ of the passenger PA when the number of passengers is two and the other passenger P is the passenger PC.

The passenger detection unit 215 detects passenger identification information DS which is information for identifying the passenger P in the vehicle 200 that the passenger PA is in. The passenger detection unit 215 detects passenger identification information DS corresponding to the passenger PA and passenger identification information DS corresponding to the other passenger P when the number of passengers in the vehicle 200 that the passenger PA is in is two.

In addition, the vehicle environment information VE includes the passenger identification information DS of the passenger P detected by the passenger detection unit 215. The vehicle environment information VE includes the passenger identification information DS corresponding to the passenger PA and the passenger identification information DS corresponding to the other passenger P.

Then, the in-vehicle history storage unit 222 stores the in-vehicle output history HJ1 of the passenger PA when the number of passengers in the vehicle 200 that the passenger PA is in is one, the in-vehicle output history HJ2 of the passenger PA when the number of passengers is two and the other passenger P is the passenger PB, and the in-vehicle output history HJ3 of the passenger PA when the number of passengers is two and the other passenger P is the passenger PC.

In FIG. 7, a left side shows an example of the in-vehicle output history HJ1, and a right side shows an example of the in-vehicle output history HJ2 and the in-vehicle output history HJ3.

In each of the in-vehicle output history HJ1, the in-vehicle output history HJ2, and the in-vehicle output history HJ3, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

The in-vehicle output history HJ1 illustrated in FIG. 7 is the same as the in-vehicle output history HJ illustrated in FIGS. 4 and 5, and is the same as the in-vehicle output history HJ1 illustrated in FIG. 6.

In other words, in the in-vehicle output history HJ1, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

The in-vehicle output history HJ2 illustrated in FIG. 7 is the same as the in-vehicle output history HJ2 illustrated in FIG. 6.

In other words, in the in-vehicle output history HJ2, the type TY of the content CB with the ranking RN being “No. 1” is the third type TY3, the type TY of the content CB with the ranking RN being “No. 2” is the first type TY1, the type TY of the content CB with the ranking RN being “No. 3” is the fourth type TY4, and the type TY of the content CB with the ranking RN being “No. 4” is the second type TY2.

In the in-vehicle output history HJ3 illustrated in FIG. 7, for example, the number of occurrences of output NT of the content CB of the first type TY1 is “5 times”, the number of occurrences of output NT of the content CB of the second type TY2 is “0 times”, the number of occurrences of output NT of the content CB of the third type TY3 is “3 times”, and the number of occurrences of output NT of the content CB of the fourth type TY4 is “8 times”.

In other words, in the in-vehicle output history HJ3, the type TY of the content CB with the ranking RN being “No. 1” is the fourth type TY4, the type TY of the content CB with the ranking RN being “No. 2” is the first type TY1, the type TY of the content CB with the ranking RN being “No. 3” is the third type TY3, and the type TY of the content CB with the ranking RN being “No. 4” is the second type TY2.

As described above, since the in-vehicle output history HJ2 and the in-vehicle output history HJ3 are different from each other, it is preferable that the in-vehicle history storage unit 222 stores the in-vehicle output history HJ2 of the passenger PA when the fellow passenger in the vehicle 200 that the passenger PA is in is the passenger PB, and the in-vehicle output history HJ3 of the passenger PA when the fellow passenger in the vehicle 200 that the passenger PA is in is the passenger PC.

In this case, when the fellow passenger in the vehicle 200 that the passenger PA is in is the passenger PB, the output control unit 214 calculates a similarity SM indicating the degree of similarity between the in-vehicle output history HJ2 and the outside-vehicle output history HQ, and controls the content CA output by the first content output unit 212 according to the similarity SM.

In addition, when the fellow passenger in the vehicle 200 that the passenger PA is in is the passenger PC, the output control unit 214 calculates a similarity SM indicating the degree of similarity between the in-vehicle output history HJ3 and the outside-vehicle output history HQ, and controls the content CA output by the first content output unit 212 according to the similarity SM.

In this way, the output control unit 214 calculates the similarity SM indicating the degree of similarity between the in-vehicle output history HJ2 or the in-vehicle output history HJ3 and the outside-vehicle output history HQ depending on whether the fellow passenger in the vehicle 200 that the passenger PA is in is the passenger PB or the passenger PC, and controls the content CA output by the first content output unit 212 according to the similarity SM, whereby the content CA suitable for the passenger P can be output depending on whether the fellow passenger in the vehicle 200 is the passenger PB or the passenger PC.

Next, a case will be described in which the vehicle environment information VE includes the driving mode CV of the vehicle 200.

The driving mode CV indicates, for example, whether the vehicle 200 is being driven by a driver or is being in automatic driving.

The driving mode detection unit 216 detects the driving mode CV.

Then, the in-vehicle history storage unit 222 stores an in-vehicle output history HJM of the passenger PA when the driving mode CV of the vehicle 200 that the passenger PA is in is being driven by the driver, and an in-vehicle output history HJA of the passenger PA when the driving mode CV of the vehicle 200 that the passenger PA is in is being in automatic driving.

The in-vehicle output history HJM and the in-vehicle output history HJA are not illustrated.

Since the in-vehicle output history HJM is the in-vehicle output history HJ when the passenger PA is driving, it is assumed that the type of the content C is limited to a music content or a radio content and does not include a moving image content, whereas since the in-vehicle output history HJA is the in-vehicle output history HJ of the passenger PA when the vehicle is being in automatic driving, the type of the content C includes a moving image content and the like.

Therefore, it is assumed that the in-vehicle output history HJM and the in-vehicle output history HJA are different from each other.

Therefore, it is preferable that the in-vehicle history storage unit 222 stores the in-vehicle output history HJM of the passenger PA when the driving mode CV of the vehicle 200 that the passenger PA is in is being driven by the driver, and the in-vehicle output history HJA of the passenger PA when the driving mode CV of the vehicle 200 that the passenger PA is in is being in automatic driving.

In this case, the output control unit 214 calculates a similarity SM indicating the degree of similarity between the in-vehicle output history HJM or the in-vehicle output history HJA and the outside-vehicle output history HQ depending on whether the driving mode CV indicates that the vehicle 200 is being driven by the driver or is being in automatic driving, and controls the content CA output by the first content output unit 212 according to the similarity SM.

In this way, the output control unit 214 calculates the similarity SM indicating the degree of similarity between the in-vehicle output history HJM or the in-vehicle output history HJA and the outside-vehicle output history HQ depending on whether the driving mode CV indicates that the vehicle 200 is being driven by the driver or is being in automatic driving, and controls the content CA output by the first content output unit 212 according to the similarity SM, whereby the content CA suitable for the passenger P can be output depending on the driving mode CV of the vehicle.

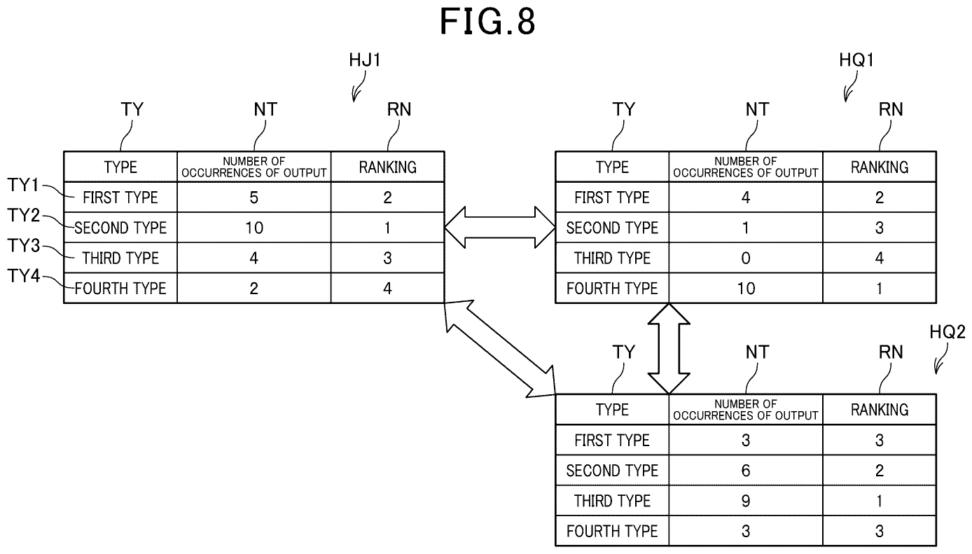

Next, a case will be described with reference to FIG. 8 in which the outside-vehicle output history HQ is classified according to each outside-vehicle environment information QE indicating the environment in which the passenger PA outputs the content CB outside the vehicle 200, and stores the number of occurrences of output NT of the content CB for each type TY of the content CB. FIG. 8 is a table illustrating an example of an in-vehicle output history HJ1, and an outside-vehicle output history HQ1 and an outside-vehicle output history HQ2 which are different in outside-vehicle environment information QE from each other.

In each of the in-vehicle output history HJ1, the outside-vehicle output history HQ1, and the outside-vehicle output history HQ2, a left column shows the type TY of the content C, a center column shows the number of occurrences of output NT of the content C, and a right column shows the ranking RN with the large number of occurrences of output NT.

The types TY of the content C include, for example, a first type TY1, a second type TY2, a third type TY3, and a fourth type TY4.

The outside-vehicle environment information QE indicates the environment in which the passenger PA outputs the content CB outside the vehicle 200. The outside-vehicle environment information QE includes, for example, home, train, motorcycle, and walking.

That “outside-vehicle environment information” is “home” indicates that the passenger PA outputs the content CB at home. That “outside-vehicle environment information” is “train” indicates that the passenger PA outputs the content CB in the train. That “outside-vehicle environment information” is “motorcycle” indicates that the passenger PA outputs the content CB while riding the motorcycle. That “outside-vehicle environment information” is “walking” indicates that the passenger PA outputs the content CB while moving on foot.

The in-vehicle output history HJ1 illustrated in FIG. 8 is the same as the in-vehicle output history HJ illustrated in FIGS. 4 and 5, and is the same as the in-vehicle output history HJ1 illustrated in FIGS. 6 and 7.

In other words, in the in-vehicle output history HJ1, the type TY of the content CA with the ranking RN being “No. 1” is the second type TY2, the type TY of the content CA with the ranking RN being “No. 2” is the first type TY1, the type TY of the content CA with the ranking RN being “No. 3” is the third type TY3, and the type TY of the content CA with the ranking RN being “No. 4” is the fourth type TY4.

The outside-vehicle output history HQ1 illustrated in FIG. 8 is, for example, the outside-vehicle output history HQ when the outside-vehicle environment information QE is “home”. In the outside-vehicle output history HQ1, for example, the number of occurrences of output NT of the content CB of the first type TY1 is “4 times”, the number of occurrences of output NT of the content CB of the second type TY2 is “1 time”, the number of occurrences of output NT of the content CB of the third type TY3 is “0 times”, and the number of occurrences of output NT of the content CB of the fourth type TY4 is “10 times”.

In other words, in the outside-vehicle output history HQ1, the type TY of the content CB with the ranking RN being “No. 1” is the fourth type TY4, the type TY of the content CB with the ranking RN being “No. 2” is the first type TY1, the type TY of the content CB with the ranking RN being “No. 3” is the second type TY2, and the type TY of the content CB with the ranking RN being “No. 4” is the third type TY3.

The outside-vehicle output history HQ2 illustrated in FIG. 8 is, for example, the outside-vehicle output history HQ when the outside-vehicle environment information QE is “motorcycle”. In the outside-vehicle output history HQ2, for example, the number of occurrences of output NT of the content CB of the first type TY1 is “3 times”, the number of occurrences of output NT of the content CB of the second type TY2 is “5 times”, the number of occurrences of output NT of the content CB of the third type TY3 is “9 times”, and the number of occurrences of output NT of the content CB of the fourth type TY4 is “3 times”.

In other words, in the outside-vehicle output history HQ2, the type TY of the content CB with the ranking RN being “No. 1” is the third type TY3, the type TY of the content CB with the ranking RN being “No. 2” is the second type TY2, and the type TY of the content CB with the ranking RN being “No. 3” is the first type TY1 and the fourth type TY4.

As described above, since the outside-vehicle output history HQ1 and the outside-vehicle output history HQ2 are different from each other, it is preferable that the outside-vehicle history storage unit 223 classifies the content CB, which is output outside the vehicle 200 by the passenger PA, according to the outside-vehicle environment information QE, and stores the number of occurrences of output NT of the content CB for each of the types TY of the content CB.

In this case, the outside-vehicle history acquisition unit 213 acquires the outside-vehicle output history HQ corresponding to the outside-vehicle environment information QE indicating the environment in which the passenger PA output the content CB immediately before entering the vehicle 200. In addition, the output control unit 214 calculates a similarity SM indicating the degree of similarity between the in-vehicle output history HJ and the outside-vehicle output history HQ, and controls the content CA output by the first content output unit 212 according to the similarity SM.

In this way, the output control unit 214 acquires the outside-vehicle output history HQ corresponding to the outside-vehicle environment information QE, calculates the similarity SM indicating the degree of similarity between the acquired outside-vehicle output history HQ and the in-vehicle output history HJ, and controls the content CA output by the first content output unit 212 according to the similarity SM, whereby the content CA suitable for the passenger P can be output according to the outside-vehicle environment information QE.

### 5. PROCESSING OF CONTENT CONTROL DEVICE

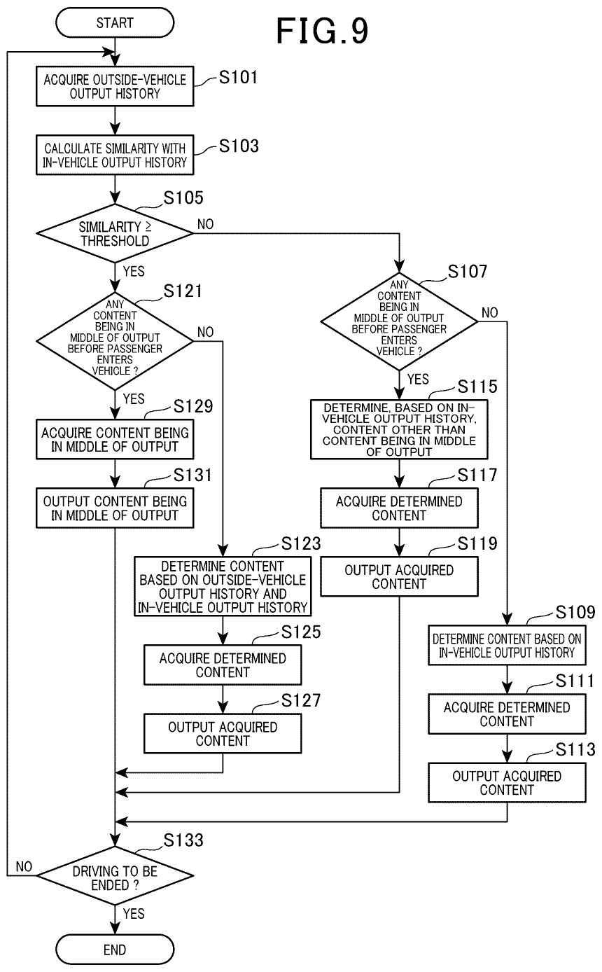

Next, the processing of the content control device 2 will be described with reference to FIG. 9. FIG. 9 is a flowchart illustrating an example of the processing of the content control device 2.

First, in step S101, the outside-vehicle history acquisition unit 213 acquires the outside-vehicle output history HQ from the smartphone 4A, and causes the outside-vehicle history storage unit 223 to store the acquired outside-vehicle output history HQ.

Next, in step S103, the output control unit 214 calculates the similarity SM indicating the degree of similarity between the outside-vehicle output history HQ and the in-vehicle output history HJ.

Next, in step S105, the output control unit 214 determines whether the similarity SM is equal to or more than the threshold TH.

When the output control unit 214 determines that the similarity SM is equal to or more than the threshold TH (step S105; YES), the output control unit 214 determines that the outside-vehicle output history HQ and the in-vehicle output history HJ are similar to each other, and the process proceeds to step S121. When the output control unit 214 determines that the similarity SM is not equal to or more than the threshold TH, that is, the similarity SM is less than the threshold TH (step S105; NO), the output control unit 214 determines that the outside-vehicle output history HQ and the in-vehicle output history HJ are not similar to each other, and the process proceeds to step S107.

Then, in step S107, the output control unit 214 determines whether there is the content CB that the passenger PA is in the middle of outputting outside the vehicle 200 before the passenger PA enters the vehicle 200.

When the output control unit 214 determines that there is the content CB that the passenger PA is in the middle of outputting outside the vehicle 200 (step S107; YES), the process proceeds to step S115. When the output control unit 214 determines that there is not the content CB that the passenger PA is in the middle of outputting outside the vehicle 200 (step S107; NO), the process proceeds to step S109.

Then, in step S109, the output control unit 214 determines the content CA based on the in-vehicle output history HJ.

Next, in step S111, the first content acquisition unit 211 acquires the determined content CA from the server device 5, and causes the content storage unit 221 to store the acquired content CA.

Next, in step S113, the first content output unit 212 outputs the acquired content CA from the output mechanism 3. Thereafter, the process proceeds to step S133.

In a case of YES in step S107, the output control unit 214 determines in step S115 the content CA other than the content CB being in the middle of output, based on the in-vehicle output history HJ.

Next, in step S117, the first content acquisition unit 211 acquires the determined content CA from the server device 5, and causes the content storage unit 221 to store the acquired content CA.

Next, in step S119, the first content output unit 212 outputs the acquired content CA from the output mechanism 3. Thereafter, the process proceeds to step S133.

In a case of YES in step S105, the output control unit 214 determines in step S121 whether there is the content CB that the passenger PA is in the middle of outputting outside the vehicle 200 before the passenger PA enters the vehicle 200.

When the output control unit 214 determines that there is the content CB that the passenger PA is in the middle of outputting outside the vehicle 200 (step S121; YES), the process proceeds to step S129. When the output control unit 214 determines that there is not the content CB that the passenger PA is in the middle of outputting outside the vehicle 200 (step S121; NO), the process proceeds to step S123.

Then, in step S123, the output control unit 214 determines the content CA based on the in-vehicle output history HJ and the outside-vehicle output history HQ.

Next, in step S125, the first content acquisition unit 211 acquires the determined content CA from the server device 5, and causes the content storage unit 221 to store the acquired content CA.

Next, in step S127, the first content output unit 212 outputs the acquired content CA from the output mechanism 3. Thereafter, the process proceeds to step S133.

In a case of YES in step S121, the first content acquisition unit 211 acquires in step S129 the content CA corresponding to the content CB being in the middle of output from the server device 5, and causes the content storage unit 221 to store the acquired content CA.

Next, in step S131, the first content output unit 212 outputs the acquired content CA from the output mechanism 3. Thereafter, the process proceeds to step S133.

In step S133, the content control device 2 determines whether or not to end the driving of the vehicle 200.

When the content control device 2 determines not to end the driving of the vehicle 200 (step S133; NO), the process returns to step S101. When the content control device 2 determines to end the driving of the vehicle 200 (step S133; YES), the process then ends.

Steps S103, S105, S109, and S123 correspond to an example of a “content control step”.

### 6. CONFIGURATIONS AND EFFECTS

As described above with reference to FIGS. 1 to 9, the content control device 2 according to the present embodiment includes: the first content output unit 212 that outputs the content CA to the passenger P seated on the seat 1 in the vehicle 200; the output control unit 214 that controls the content CA output by the first content output unit 212; the in-vehicle history storage unit 222 that classifies the content CA output by the first content output unit 212 according to each of the types TY of the content CA and stores, as the in-vehicle output history HJ, the number of occurrences of output NT of the content CA for each of the types TY of the content in association with the passenger P; and the outside-vehicle history acquisition unit 213 that classifies the content CB output outside the vehicle 200 by the passenger P according to each of the types TY of the content CB and acquires, as the outside-vehicle output history HQ, the number of occurrences of output NT of the content CB for each of the types TY of the content, and the output control unit 214 calculates the similarity SM indicating the degree of similarity between the in-vehicle output history HJ and the outside-vehicle output history HQ, and controls the content CA output by the first content output unit 212 according to the similarity SM.

According to such a configuration, the similarity SM is calculated that indicates the degree of similarity between the in-vehicle output history HJ and the outside-vehicle output history HQ, and the content CA output by the first content output unit 212 is controlled according to the similarity SM, whereby the content CA suitable for the passenger P of the vehicle 200 can be controlled according to a tendency of usage of the content CB outside the vehicle 200.

In the content control device 2, the type TY of the content C includes at least one of a website that delivers the content C and a genre of the content C.

According to such a configuration, since the type TY of the content C includes at least one of the website that delivers the content C and the genre of the content C, it is possible to appropriately calculate the similarity SM indicating the degree of similarity between the in-vehicle output history HJ and the outside-vehicle output history HQ.

In the content control device 2, when the similarity SM is equal to or more than the preset threshold TH, the output control unit 214 controls the content CA output by the first content output unit 212, based on the in-vehicle output history HJ and the outside-vehicle output history HQ.

According to such a configuration, when the similarity SM is equal to or more than the preset threshold TH, the in-vehicle output history HJ and the outside-vehicle output history HQ are similar to each other. Therefore, the content CA output by the first content output unit 212 is controlled based on the in-vehicle output history HJ and the outside-vehicle output history HQ, and thus it is possible to control the content CA suitable for the passenger P of the vehicle 200.

In the content control device 2, when the similarity SM is equal to or more than the preset threshold TH, the output control unit 214 controls, when there is the content CB being in the middle of output by the passenger P outside the vehicle 200 before the passenger P enters the vehicle 200 in the outside-vehicle output history HQ, the first content output unit 212 to output the content CA corresponding to the content CB being in the middle of output from the middle of output.

According to such a configuration, when the similarity SM is equal to or more than the preset threshold TH, the in-vehicle output history HJ and the outside-vehicle output history HQ are similar to each other. Therefore, when there is the content CB being in the middle of output by the passenger P outside the vehicle 200 before the passenger P enters the vehicle 200, the first content output unit 212 is controlled to output the content CA corresponding to the content CB being in the middle of output from the middle of output, whereby it is possible to content CA suitable for the passenger P of the vehicle 200.

In the content control device 2, when the similarity SM is less than the threshold TH, the output control unit 214 controls the content CA output by the first content output unit 212, based on the in-vehicle output history HJ.

According to such a configuration, when the similarity SM is less than the threshold TH, the in-vehicle output history HJ and the outside-vehicle output history HQ are not similar to each other. In this case, there is a possibility that the passenger P selectively uses the type TY of the content CA to be output when being in the vehicle 200 and the type TY of the content CB to be output outside the vehicle 200. Therefore, the content CA output by the first content output unit 212 is controlled based on the in-vehicle output history HJ, and thus it is possible to control the content CA suitable for the passenger P of the vehicle 200.

In the content control device 2, when the similarity SM is less than the threshold TH, the output control unit 214 controls the content CA output by the first content output unit 212 so as to preferentially output the type TY of the content CB whose number of occurrences of output NT is equal to or less than the predetermined number of times in the outside-vehicle output history HQ, from among the types TY of the content CA involved in the in-vehicle output history HJ.

According to such a configuration, when the similarity SM is less than the threshold TH, the in-vehicle output history HJ and the outside-vehicle output history HQ are not similar to each other. Therefore, the content CA output by the first content output unit 212 is controlled so as to preferentially output the type TY of the content CB whose number of occurrences of output NT is equal to or less than the predetermined number of times in the outside-vehicle output history HQ, from among the types of the content CA involved in the in-vehicle output history HJ, whereby it is possible to control the content CA suitable for the passenger P of the vehicle 200 according to the tendency of usage of the content CB outside the vehicle 200 by appropriately setting the predetermined number of times.

In the content control device 2, in the case where the similarity SM is less than the threshold TH, when there are a plurality of types TY of the content CB whose number of occurrences of output NT is equal to or less than the predetermined number of times in the outside-vehicle output history HQ, from among the types TY of the content CA involved in the in-vehicle output history HJ and when the plurality of types TY of the content CB include the type TY of the content CB whose number of occurrences of output NT is zero in the outside-vehicle output history HQ and the type TY of the content CB whose number of occurrences of output NT is one or more in the outside-vehicle output history HQ, the output control unit 214 controls the content CA output by the first content output unit 212 so as to output the type TY of the content CB whose number of occurrences of output NT is one or more in the outside-vehicle output history HQ in preference to the type TY of the content CB whose number of occurrences of output NT is zero in the outside-vehicle output history HQ.

According to such a configuration, the content CA output by the first content output unit 212 is controlled so as to output the type TY of the content CB whose number of occurrences of output NT is one or more in the outside-vehicle output history HQ in preference to the type TY of the content CB whose number of occurrences of output NT is zero in the outside-vehicle output history HQ. The type TY of the content CB whose number of occurrences of output NT is zero in the outside-vehicle output history HQ may not suit taste of the passenger, for example. Therefore, it is possible to control the content CA suitable for the passenger P of the vehicle 200 according to the tendency of usage of the content CB outside the vehicle.

In the content control device 2, in the case where the similarity SM is less than the threshold TH, when there is the content CB being in the middle of output by the passenger P outside the vehicle 200 before the passenger P enters the vehicle 200 in the outside-vehicle output history HQ, the output control unit 214 controls the content CA output by the first content output unit 212 so as to output, based on the in-vehicle output history HJ, the content CA other than the content CA corresponding to the content CB being in the middle of output.

According to such a configuration, when the similarity SM is less than the threshold TH, the in-vehicle output history HJ and the outside-vehicle output history HQ are not similar to each other. In this case, there is a possibility that the passenger P selectively uses the type TY of the content CA to be output when being in the vehicle 200 and the type TY of the content CB to be output outside the vehicle 200. Therefore, for example, when there is the content CB being in the middle of output by the passenger P outside the vehicle 200 before the passenger P enters the vehicle 200, the content CA output by the first content output unit 212 is controlled so as to output, based on the in-vehicle output history HJ, the content CA other than the content CA corresponding to the content CB being in the middle of output. Therefore, it is possible to control the content CA suitable for the passenger P of the vehicle 200 according to the tendency of usage of the content CB outside the vehicle 200.

In the content control device 2, when the similarity SM is less than the threshold TH, the output control unit 214 controls the content CA output by the first content output unit 212 so as to output the type TY of the content C whose number of occurrences of output NT is zero in the in-vehicle output history HJ and the outside-vehicle output history HQ.

According to such a configuration, the content CA output by the first content output unit 212 is controlled so as to output the type TY of the content C whose number of occurrences of output NT is zero in the in-vehicle output history HJ and the outside-vehicle output history HQ, and thus the content CA is output that has never been viewed by the passenger P. Therefore, when the passenger P wishes to view the content CA that the passenger P has never viewed in the vehicle 200, the content CA can be output that the passenger P wishes to view.

In the content control device 2, the in-vehicle history storage unit 222 further classifies the content CA output by the first content output unit 212 as the in-vehicle output history HJ according to each vehicle environment information VE including the passenger information regarding the passenger P of the vehicle 200 that the passenger P is in, and stores the number of occurrences of output NT of the content CA for each vehicle environment information VE in association with the passenger P, and the output control unit 214 calculates the similarity SM indicating the degree of similarity between the in-vehicle output history HJ corresponding to the vehicle environment information VE of the vehicle 200 that the passenger P is in and the outside-vehicle output history HQ, and controls the content CA output by the first content output unit 212 according to the similarity SM.

According to such a configuration, the similarity SM is calculated which indicates the degree of similarity between the in-vehicle output history HJ corresponding to the vehicle environment information VE of the vehicle 200 that the passenger P is in and the outside-vehicle output history HQ, and the content CA output by the first content output unit 212 is controlled according to the similarity SM. Therefore, it is possible to control the content CA suitable for the passenger P of the vehicle 200 according to the tendency of usage of the content CB outside the vehicle 200 by appropriately setting the vehicle environment information VE.

In the content control device 2, the content control device further includes the passenger detection unit 215 that detects the seating position of the passenger P in the vehicle 200 that the passenger P is in, the vehicle environment information VE includes the seating position of the passenger P detected by the passenger detection unit 215, and the output control unit 214 calculates the similarity SM indicating the degree of similarity between the in-vehicle output history HJ corresponding to the seating position where the passenger P is seated and the outside-vehicle output history HQ, and controls the content CA output by the first content output unit 212 according to the similarity SM.

According to such a configuration, the similarity SM is calculated which indicates the degree of similarity between the in-vehicle output history HJ corresponding to the seating position where the passenger P is seated and the outside-vehicle output history HQ, and the content CA output by the first content output unit 212 is controlled according to the similarity SM. Therefore, it is possible to control the content CA suitable for the passenger P of the vehicle 200 according to the seating position where the passenger P is seated.

In the content control device 2, the content control device further includes the passenger detection unit 215 that detects the number of passengers P in the vehicle 200 that the passenger P is in, the vehicle environment information VE includes the number of passengers P detected by the passenger detection unit 215, and the output control unit 214 calculates, when the number of passengers P in the vehicle 200 that the passenger P is in is one, the similarity SM indicating the degree of similarity between the in-vehicle output history HJ corresponding to the case where the number of passengers in the vehicle 200 is one and the outside-vehicle output history HQ, and controls the content CA output by the first content output unit 212 according to the similarity SM, and calculates, when the number of passengers P in the vehicle 200 that the passenger P is in is many, the similarity SM indicating the degree of similarity between the in-vehicle output history HJ corresponding to the case where the number of passengers in the vehicle 200 is many and the outside-vehicle output history HQ, and controls the content CA output by the first content output unit 212 according to the similarity SM.

According to such a configuration, when the number of passengers P in the vehicle 200 that the passenger P is in is one, the similarity SM is calculated which indicates the degree of similarity between the in-vehicle output history HJ corresponding to the case where the number of passengers in the vehicle 200 is one and the outside-vehicle output history HQ, and the content CA output by the first content output unit 212 is controlled according to the similarity SM. Furthermore, when the number of passengers P in the vehicle 200 that the passenger P is in is many, the similarity SM is calculated which indicates the degree of similarity between the in-vehicle output history HJ corresponding to the case where the number of passengers in the vehicle 200 is many and the outside-vehicle output history HQ, and the content CA output by the first content output unit 212 is controlled according to the similarity SM. Therefore, it is possible to control the content CA suitable for the passenger P of the vehicle 200 depending on whether the number of passengers in the vehicle 200 that the passenger P is in is one or many.

In the content control device 2, the passenger detection unit 215 detects the passenger identification information DS, which is information for identifying the passenger P in the vehicle 200 that the passenger PA is in, the vehicle environment information VE includes the passenger identification information DS of the passenger P detected by the passenger detection unit 215, and the output control unit 214 calculates the similarity SM indicating the degree of similarity between the in-vehicle output history HJ corresponding to the passenger identification information DS indicating the passenger P other than the passenger PA detected by the passenger detection unit 215 and the outside-vehicle output history HQ, and controls the content CA output by the first content output unit 212 according to the similarity SM.

According to such a configuration, the similarity SM is calculated which indicates the degree of similarity between the in-vehicle output history HJ corresponding to the passenger identification information DS indicating the passenger P detected by the passenger detection unit 215 and the outside-vehicle output history HQ, and the content CA output by the first content output unit 212 is controlled according to the similarity SM. Therefore, it is possible to control the content CA suitable for the passenger PA of the vehicle 200 depending on who the fellow passenger is.

In the content control device 2, the content control device further includes the driving mode detection unit 216 that detects the driving mode CV indicating whether the vehicle 200 is being in automatic driving, the vehicle environment information VE includes the driving mode CV, and the output control unit 214 calculates the similarity SM indicating the degree of similarity between the in-vehicle output history HJ corresponding to the driving mode CV of the vehicle 200 and the outside-vehicle output history HQ, and controls the content CA output by the first content output unit 212 according to the similarity SM.

According to such a configuration, the similarity SM is calculated which indicates the degree of similarity between the in-vehicle output history HJ corresponding to the driving mode CV of the vehicle 200 indicating whether the vehicle 200 is being in automatic driving and the outside-vehicle output history HQ, and the content CA output by the first content output unit 212 is controlled according to the similarity SM. Therefore, it is possible to control the content CA suitable for the passenger P of the vehicle 200 depending on whether the vehicle 200 is being automatic driving.

In the content control device 2, the outside-vehicle output history HQ is classified according to each outside-vehicle environment information QE indicating the environment in which the passenger P outputs the content CB outside the vehicle 200, and stores the number of occurrences of output NT of the content CB for each type TY of the content CB which is output outside the vehicle 200 by the passenger P, the outside-vehicle history acquisition unit 213 acquires the outside-vehicle output history HQ corresponding to the outside-vehicle environment information QE indicating the environment in which the content CB is output immediately before the passenger P enters the vehicle 200, and the output control unit 214 calculates the similarity SM indicating the degree of similarity between the in-vehicle output history HJ and the outside-vehicle output history HQ, and controls the content CA output by the first content output unit 212 according to the similarity SM.

According to such a configuration, the outside-vehicle output history HQ corresponding to the outside-vehicle environment information QE is acquired, the outside-vehicle environment information QE indicating the environment in which the content CB is output immediately before the passenger P enters the vehicle 200, and the output control unit 214 calculates the similarity SM indicating the degree of similarity between the in-vehicle output history HJ and the outside-vehicle output history HQ, and controls the content CA output by the first content output unit 212 according to the similarity SM. Therefore, it is possible to control the content CA suitable for the passenger P of the vehicle 200 according to the environment in which the content CB is output immediately before the passenger P enters the vehicle 200.

The content control method according to the present embodiment is performed by the content control device 2 including: the first content output unit 212 that outputs the content CA to the passenger P seated on the seat 1 in the vehicle 200; the output control unit 214 that controls the content CA output by the first content output unit 212; the in-vehicle history storage unit 222 that classifies the content CA output by the first content output unit 212 according to each of the types TY of the content CA and stores, as the in-vehicle output history HJ, the number of occurrences of output NT of the content CA for each of the types TY of the content in association with the passenger P; and the outside-vehicle history acquisition unit 213 that classifies the content CB output outside the vehicle 200 by the passenger P according to each of the types TY of the content CB and acquires, as the outside-vehicle output history HQ, the number of occurrences of output NT of the content CB for each of the types TY of the content CB, and the output control unit 214 executes a content control step of calculating the similarity SM indicating the degree of similarity between the in-vehicle output history HJ and the outside-vehicle output history HQ, and controlling the content CA output by the first content output unit 212 according to the similarity SM.

Therefore, the content control method according to the present embodiment has the same operational effects as the content control device 2 according to the present embodiment.

The first control program PG1 according to the present embodiment causes the first processor 21 included in the content control device 2 arranged in the vehicle 200 to function as: the first content output unit 212 that outputs the content CA to the passenger P seated on the seat 1 in the vehicle 200; the output control unit 214 that controls the content CA output by the first content output unit 212; the in-vehicle history storage unit 222 that classifies the content CA output by the first content output unit 212 according to each of the types TY of the content CA and stores, as the in-vehicle output history HJ, the number of occurrences of output NT of the content CA for each of the types TY of the content in association with the passenger P; and the outside-vehicle history acquisition unit 213 that classifies the content CB output outside the vehicle 200 by the passenger P according to each of the types TY of the content CB and acquires, as the outside-vehicle output history HQ, the number of occurrences of output NT of the content CB for each of the types TY of the content CB, and the output control unit 214 calculates the similarity SM indicating the degree of similarity between the in-vehicle output history HJ and the outside-vehicle output history HQ, and controls the content CA output by the first content output unit 212 according to the similarity SM.

Therefore, the first program PG1 according to the present embodiment has the same operational effects as the content control device 2 according to the present embodiment.

The content control system 100 according to the present embodiment includes the content control device 2 and the smartphone 4 communicably connected to the content control device 2, the content control device 2 including: the first content output unit 212 that outputs the content CA to the passenger P seated on the seat 1 in the vehicle 200; the output control unit 214 that controls the content CA output by the first content output unit 212; and the in-vehicle history storage unit 222 that classifies the content CA output by the first content output unit 212 according to each of the types TY of the content CA and stores, as the in-vehicle output history HJ, the number of occurrences of output NT of the content CA for each of the types TY of the content in association with the passenger P, the content control device 2 further includes the outside-vehicle history acquisition unit 213 that classifies the content CB output outside the vehicle 200 from the smartphone 4 by the passenger P according to each of the types TY of the content CB and acquires, as the outside-vehicle output history HQ, the number of occurrences of output NT of the content CB for each of the types TY of the content CB, and the output control unit 214 calculates the similarity SM indicating the degree of similarity between the in-vehicle output history HJ and the outside-vehicle output history HQ, and controls the content CA output by the first content output unit 212 according to the similarity SM.

Therefore, the content control system 100 according to the present embodiment has the same operational effects as the content control device 2 according to the present embodiment.

### 7. OTHER EMBODIMENTS

The above-described embodiment is a preferred embodiment of the present invention. However, the present invention is not limited to the above-described embodiment, and various modifications are possible within the scope of the gist of the present invention.

In the present embodiment, a case has been described in which the seat 1 is composed of five seats, that is, the first seat 11, the second seat 12, the third seat 13, the fourth seat 14, and the fifth seat 15, but embodiments are not limited thereto. The seat 1 may be composed of three seats, for example. The seat 1 may be composed of four seats, for example. The seat 1 may be composed of six or more seats, for example.

In the present embodiment, a case has been described in which the output mechanism 3 includes the touch panel TP and the speaker SP, but embodiments are not limited thereto. For example, the touch panel TP and the speaker SP may be arranged separately.

In the present embodiment, a case has been described in which the “information processing device” is the smartphone 4, but embodiments are not limited thereto. The “information processing device” may be, for example, a tablet computer. The “information processing device” may be, for example, a notebook personal computer. The “information processing device” may be, for example, a desktop personal computer.

In the present embodiment, a case has been described in which the type TY of the content C is the genre of the content C, but embodiments are not limited thereto. The type TY of the content C may include at least one of a website that delivers the content C and a genre of the content C. The type TY of the content C may be, for example, a website that delivers the content C and a genre of the content C. In addition, the type TY of the content C may be, for example, a website that delivers the content C.

In the present embodiment, a case has been mainly described in which the “passenger” is the passenger PA, but embodiments are not limited thereto. The “passenger” may be the passenger P other than the passenger PA. For example, the “passenger” may be the passenger PB, the passenger PC, or the passenger PD.

In the present embodiment, a case has been mainly described in which the one camera CM generates the image PT, but embodiments are not limited thereto. A plurality of cameras CM may generate the image PT. For example, a camera CM may be arranged in each of the first output mechanism 31, the second output mechanism 32, the third output mechanism 33, the fourth output mechanism 34, and the fifth output mechanism 35.

In the present embodiment, a case has been mainly described in which the output control unit 214 preferentially outputs the type TY of the content CB whose number of occurrences of output NT is equal to or less than the predetermined number of times in the outside-vehicle output history HQ, from among the types TY of the content CA involved in the in-vehicle output history HJ, but embodiments are not limited thereto. For example, the output control unit 214 may preferentially output the type TY of the content CB with a predetermined ranking RN or less in the outside-vehicle output history HQ, from among the types TY of the content CA involved in the in-vehicle output history HJ. The predetermined ranking RN is, for example, “No. 3”.

For example, the content control device 2 illustrated in FIG. 3 shows a functional configuration, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, for example, the processing units in the flowchart illustrated in FIG. 9 are divided according to the main processing contents to make the processing of the content control device 2 easier to understand, and the present invention is not limited by the manner in which the processing units are divided or the names of the processing units illustrated in the flowchart of FIG. 9. The processing of the content control device 2 may be divided into more processing units depending on the processing contents, or one processing unit may be divided so as to include more processing. In addition, the processing order of the above flowchart is not also limited to the example illustrated in the drawings.

### 8. CONFIGURATION SUPPORTED BY EMBODIMENT

The above-described embodiment supports the following configurations.

### (Configuration 1)

A content control device including: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit calculates a similarity indicating the degree of similarity between the in-vehicle output history and the outside-vehicle output history, and controls the content output by the content output unit according to the similarity.

According to the content control device of Configuration 1, the similarity is calculated that indicates the degree of similarity between the in-vehicle output history and the outside-vehicle output history, and the content output by the content output unit is controlled according to the similarity, whereby the content suitable for the passenger of the vehicle can be controlled according to a tendency of usage of the content outside the vehicle.

### (Configuration 2)

In the content control device according to Configuration 1, the type of the content includes at least one of a website that delivers the content and a genre of the content.

According to the content control device of Configuration 2, since the type of the content includes at least one of the website that delivers the content and the genre of the content, it is possible to appropriately calculate the similarity indicating the degree of similarity between the in-vehicle output history and the outside-vehicle output history.

### (Configuration 3)

In the content control device according to Configuration 1 or 2, when the similarity is equal to or more than a preset threshold, the output control unit controls the content output by the content output unit, based on the in-vehicle output history and the outside-vehicle output history.

According to the content control device of Configuration 3, when the similarity is equal to or more than the preset threshold, the in-vehicle output history and the outside-vehicle output history are similar to each other. Therefore, the content output by the content output unit is controlled based on the in-vehicle output history and the outside-vehicle output history, and thus it is possible to control the content suitable for the passenger of the vehicle.

### (Configuration 4)

In the content control device according to any one of Configurations 1 to 3, when the similarity is equal to or more than the preset threshold, and when there is a content being in the middle of output by the passenger outside the vehicle before the passenger enters the vehicle in the outside-vehicle output history, the output control unit controls the content output unit to output the content being in the middle of output from the middle of output.

According to the content control device of Configuration 4, when the similarity is equal to or more than the preset threshold, the in-vehicle output history and the outside-vehicle output history are similar to each other. Therefore, when there is the content being in the middle of output by the passenger outside the vehicle before the passenger enters the vehicle, the content output unit is controlled to output the content corresponding to the content being in the middle of output from the middle of output, whereby it is possible to control the content suitable for the passenger of the vehicle.

### (Configuration 5)

In the content control device according to any one of Configurations 1 to 4, when the similarity is less than the threshold, the output control unit controls the content output by the content output unit, based on the in-vehicle output history.

According to the content control device of Configuration 5, when the similarity is less than the threshold, the in-vehicle output history and the outside-vehicle output history are not similar to each other. In this case, there is a possibility that the passenger selectively uses the type of the content to be output when being in the vehicle and the type of the content to be output outside the vehicle. Therefore, the content output by the content output unit is controlled based on the in-vehicle output history, and thus it is possible to control the content suitable for the passenger of the vehicle.

### (Configuration 6)

In the content control device according to Configuration 5, when the similarity is less than the threshold, the output control unit controls the content output by the content output unit so as to preferentially output a type of a content whose number of occurrences of output is equal to or less than a predetermined number of times in the outside-vehicle output history, from among the types of the content involved in the in-vehicle output history.

According to the content control device of Configuration 6, when the similarity is less than the threshold, the in-vehicle output history and the outside-vehicle output history are not similar to each other. Therefore, the content output by the content output unit is controlled so as to preferentially output the type of the content whose number of occurrences of output is equal to or less than the predetermined number of times in the outside-vehicle output history, from among the types of the content involved in the in-vehicle output history, whereby it is possible to control the content suitable for the passenger of the vehicle according to the tendency of usage of the content outside the vehicle by appropriately setting the predetermined number of times.

### (Configuration 7)

In the content control device according to Configuration 5 or 6, in a case where the similarity is less than the threshold, when there are a plurality of types of the content whose number of occurrences of output is equal to or less than the predetermined number of times in the outside-vehicle output history, from among the types of the content involved in the in-vehicle output history, and when the plurality of types of the content include a type of a content whose number of occurrences of output is zero in the outside-vehicle output history and a type of a content whose number of occurrences of output is one or more in the outside-vehicle output history, the output control unit controls the content output by the content output unit so as to output the type of the content whose number of occurrences of output is one or more in the outside-vehicle output history in preference to the type of the content whose number of occurrences of output is zero in the outside-vehicle output history.

According to the content control device of Configuration 7, the content output by the content output unit is controlled so as to output the type of the content whose number of occurrences of output is one or more in the outside-vehicle output history in preference to the type of the content whose number of occurrences of output is zero in the outside-vehicle output history. The type of the content whose number of occurrences of output is zero in the outside-vehicle output history may not suit taste of the passenger, for example. Therefore, it is possible to control the content suitable for the passenger of the vehicle according to the tendency of usage of the content outside the vehicle.

### (Configuration 8)

In the content control device according to any one of Configurations 5 to 7, when the similarity is less than the threshold, and when there is the content being in the middle of output by the passenger outside the vehicle before the passenger enters the vehicle in the outside-vehicle output history, the output control unit controls the content output by the content output unit so as to output, based on the in-vehicle output history, a content other than the content being in the middle of output.

According to the content control device of Configuration 8, when the similarity is less than the threshold, the in-vehicle output history and the outside-vehicle output history are not similar to each other. In this case, there is a possibility that the passenger selectively uses the type of the content to be output when being in the vehicle and the type of the content to be output outside the vehicle. Therefore, for example, when there is the content being in the middle of output by the passenger outside the vehicle before the passenger enters the vehicle, the content output by the content output unit is controlled so as to output, based on the in-vehicle output history, the content other than the content corresponding to the content being in the middle of output. Therefore, it is possible to control the content suitable for the passenger of the vehicle according to the tendency of usage of the content outside the vehicle.

### (Configuration 9)

In the content control device according to any one of Configurations 5 to 8, when the similarity is less than the threshold, the output control unit controls the content output by the content output unit so as to output the type of the content whose number of occurrences of output is zero in the in-vehicle output history and the outside-vehicle output history.

According to the content control device of Configuration 9, the content output by the content output unit is controlled so as to output the type of the content whose number of occurrences of output is zero in the in-vehicle output history and the outside-vehicle output history, and thus the content is output that has never been viewed by the passenger. Therefore, when the passenger wishes to view the content that the passenger has never viewed in the vehicle before, the content can be output that the passenger wishes to view.

### (Configuration 10)

In the content control device according to Configuration 1 or 2, the history storage unit further classifies the content output by the content output unit as the in-vehicle output history according to each vehicle environment information including passenger information regarding the passenger of the vehicle that the passenger is in, and stores the number of occurrences of output of the content for each vehicle environment information in association with the passenger, and the output control unit calculates the similarity indicating the degree of similarity between the in-vehicle output history corresponding to the vehicle environment information of the vehicle that the passenger is in and the outside-vehicle output history, and controls the content output by the content output unit according to the similarity.

According to the content control device of Configuration 10, the similarity is calculated which indicates the degree of similarity between the in-vehicle output history corresponding to the vehicle environment information of the vehicle that the passenger is in and the outside-vehicle output history, and the content output by the content output unit is controlled according to the similarity. Therefore, it is possible to control the content suitable for the passenger of the vehicle according to the tendency of usage of the content outside the vehicle by appropriately setting the vehicle environment information.

### (Configuration 11)

In the content control device according to Configuration 10, the content control device further includes a passenger detection unit that detects a seating position of the passenger in the vehicle that the passenger is in, in which, the vehicle environment information includes the seating position of the passenger detected by the passenger detection unit, and the output control unit calculates the similarity indicating the degree of similarity between the in-vehicle output history corresponding to the seating position where the passenger is seated and the outside-vehicle output history, and controls the content output by the content output unit according to the similarity.

According to the content control device of Configuration 11, the similarity is calculated which indicates the degree of similarity between the in-vehicle output history corresponding to the seating position where the passenger is seated and the outside-vehicle output history, and the content output by the content output unit is controlled according to the similarity. Therefore, it is possible to control the content suitable for the passenger according to the seating position where the passenger is seated.

### (Configuration 12)

In the content control device according to Configuration 10 or 11, the content control device further includes a passenger detection unit that detects the number of passengers in the vehicle that the passenger is in, in which, the vehicle environment information includes the number of passengers detected by the passenger detection unit, when the number of passengers in the vehicle that the passenger is in is one, the output control unit calculates the similarity indicating the degree of similarity between the in-vehicle output history corresponding to the case where the number of passengers in the vehicle is one and the outside-vehicle output history, and controls the content output by the content output unit according to the similarity, and when the number of passengers in the vehicle that the passenger is in is many, the output control unit calculates the similarity indicating the degree of similarity between the in-vehicle output history corresponding to the case where the number of passengers in the vehicle is many and the outside-vehicle output history, and controls the content output by the content output unit according to the similarity.

According to the content control device of Configuration 12, when the number of passengers in the vehicle that the passenger is in is one, the similarity is calculated which indicates the degree of similarity between the in-vehicle output history corresponding to the case where the number of passengers in the vehicle is one and the outside-vehicle output history, and the content output by the content output unit is controlled according to the similarity. Furthermore, when the number of passengers in the vehicle that the passenger is in is many, the similarity is calculated which indicates the degree of similarity between the in-vehicle output history corresponding to the case where the number of passengers in the vehicle is many and the outside-vehicle output history, and the content output by the content output unit is controlled according to the similarity. Therefore, it is possible to control the content suitable for the passenger of the vehicle depending on whether the number of passengers in the vehicle that the passenger is in is one or many.

### (Configuration 13)

In the content control device according to Configuration 12, the passenger detection unit detects passenger identification information, which is information for identifying the passenger in the vehicle that the passenger is in, the vehicle environment information includes the passenger identification information of the passenger detected by the passenger detection unit, and the output control unit calculates the similarity indicating the degree of similarity between the in-vehicle output history corresponding to the passenger identification information indicating the passenger other than the passenger detected by the passenger detection unit and the outside-vehicle output history, and controls the content output by the content output unit according to the similarity.

According to the content control device of Configuration 13, the similarity is calculated which indicates the degree of similarity between the in-vehicle output history corresponding to the passenger identification information indicating the passenger detected by the passenger detection unit and the outside-vehicle output history, and the content output by the content output unit is controlled according to the similarity. Therefore, it is possible to control the content suitable for the passenger of the vehicle depending on who the fellow passenger is.

### (Configuration 14)

In the content control device according to any one of Configurations 10 to 13, the content control device further includes a driving mode detection unit that detects a driving mode indicating whether the vehicle is being in automatic driving, in which, the vehicle environment information includes the driving mode, and the output control unit calculates the similarity indicating the degree of similarity between the in-vehicle output history corresponding to the driving mode of the vehicle and the outside-vehicle output history, and controls the content output by the content output unit according to the similarity.

According to the content control device of Configuration 14, the similarity is calculated which indicates the degree of similarity between the in-vehicle output history corresponding to the driving mode of the vehicle indicating whether the vehicle is being in automatic driving and the outside-vehicle output history, and the content output by the content output unit is controlled according to the similarity. Therefore, it is possible to control the content suitable for the passenger of the vehicle depending on whether the vehicle is being automatic driving.

### (Configuration 15)

In the content control device according to Configuration 1 or 2, the outside-vehicle output history is classified according to each outside-vehicle environment information indicating an environment in which the passenger outputs a content outside the vehicle, and stores the number of occurrences of output of the content for each type of the content which is output outside the vehicle by the passenger, the outside-vehicle history acquisition unit acquires the outside-vehicle output history corresponding to the outside-vehicle environment information indicating the environment in which the passenger outputs the content immediately before entering the vehicle, and the output control unit calculates the similarity indicating the degree of similarity between the in-vehicle output history and the outside-vehicle output history, and controls the content output by the content output unit according to the similarity.

According to the content control device of Configuration 15, the outside-vehicle output history corresponding to the outside-vehicle environment information is acquired, the outside-vehicle environment information indicating the environment in which the content is output immediately before the passenger enters the vehicle, and the output control unit calculates the similarity indicating the degree of similarity between the in-vehicle output history and the outside-vehicle output history, and controls the content output by the content output unit according to the similarity. Therefore, it is possible to control the content suitable for the passenger of the vehicle according to the environment in which the content is output immediately before the passenger enters the vehicle.

### (Configuration 16)

A content control method performed by a content control device, the content control device including: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit executes a content control step of calculating a similarity indicating the degree of similarity between the in-vehicle output history and the outside-vehicle output history, and controlling the content output by the content output unit according to the similarity.

The content control method of Configuration 16 has the same configuration as the content control device of Configuration 1, and thus has the same operational effects as the content control device of Configuration 1.

### (Configuration 17)

A non-transitory computer readable storage medium storing a content control program causes a processor provided in a content control device arranged in a vehicle to function as: a content output unit that outputs a content to a passenger seated on a seat in a vehicle; an output control unit that controls the content output by the content output unit; a history storage unit that classifies the content output by the content output unit according to each of types of the content and stores, as an in-vehicle output history, the number of occurrences of output of the content for each of the types of the content in association with the passenger; and an outside-vehicle history acquisition unit that classifies a content output outside the vehicle by the passenger according to each of types of the content and acquires, as an outside-vehicle output history, the number of occurrences of output of the content for each of the types of the content, in which, the output control unit calculates a similarity indicating the degree of similarity between the in-vehicle output history and the outside-vehicle output history, and controls the content output by the content output unit according to the similarity.

The storage medium of Configuration 17 has the same configuration as the content control device of Configuration 1, and thus has the same operational effects as the content control device of Configuration 1.

### (Configuration 18)

A content control system including: a content control device; and an information processing device communicably connected to the content control device, the content control device including: a content output unit that outputs a content to a passenger seated on a seat in a vehicle; an output control unit that controls the content output by the content output unit; and a history storage unit that classifies the content output by the content output unit according to each of types of the content and stores, as an in-vehicle output history, the number of occurrences of output of the content for each of the types of the content in association with the passenger, in which, the content control device further includes an outside-vehicle history acquisition unit that classifies a content output outside the vehicle from the information processing device by the passenger according to each of types of the content and acquires, as an outside-vehicle output history, the number of occurrences of output of the content for each of the types of the content, and the output control unit calculates a similarity indicating the degree of similarity between the in-vehicle output history and the outside-vehicle output history, and controls the content output by the content output unit according to the similarity.

The content control system of Configuration 18 has the same configuration as the content control device of Configuration 1, and thus has the same operational effects as the content control device of Configuration 1.

### REFERENCE SIGNS LIST

100 content control system
200 vehicle
1 seat
11 first seat
12 second seat
2 content control device
21 first processor (processor)
211 content acquisition unit (part of content output unit)
212 first content output unit (part of content output unit)
213 outside-vehicle history acquisition unit
214 output control unit
215 passenger detection unit
216 driving mode detection unit
22 first memory
221 content storage unit
222 in-vehicle history storage unit (history storage unit)
223 outside-vehicle history storage unit
23 communication interface
3 output mechanism
31 first output mechanism
311 first touch panel
312 first speaker
32 second output mechanism
33 third output mechanism
35 fifth output mechanism
4 smartphone (information processing device)
42 second processor
421 second content acquisition unit
422 second content output unit
43 second memory
431 outside-vehicle history storage unit
5 server device
51 first server device
C, CA, CB content
CM camera
CV driving mode
DS passenger identification information
HJ, HJ1, HJ2, HJ3 in-vehicle output history
HQ, HQ1, HQ2 outside-vehicle output history
NT number of occurrences of output
P, PA, PB, PC, PD passenger
PG1 first control program (content control program)
PG2 second control program
PT image
QE outside-vehicle environment information
RN ranking
SM similarity
SP speaker
TH threshold
TP touch panel
TY type
VE vehicle environment information

1. A content control device comprising:
a content output unit that outputs a content to a passenger seated on a seat in a vehicle;
an output control unit that controls the content output by the content output unit;
a history storage unit that classifies the content output by the content output unit according to each of types of the content and stores, as an in-vehicle output history, the number of occurrences of output of the content for each of the types of the content in association with the passenger; and
an outside-vehicle history acquisition unit that classifies a content output outside the vehicle by the passenger according to each of types of the content and acquires, as an outside-vehicle output history, the number of occurrences of output of the content for each of the types of the content, wherein
the output control unit calculates a similarity indicating the degree of similarity between the in-vehicle output history and the outside-vehicle output history, and controls the content output by the content output unit according to the similarity.

2. The content control device according to claim 1, wherein
the type of the content includes at least one of a website that delivers the content and a genre of the content.

3. The content control device according to claim 1, wherein
when the similarity is equal to or more than a preset threshold,
the output control unit controls the content output by the content output unit, based on the in-vehicle output history and the outside-vehicle output history.

4. The content control device according to claim 3, wherein
when the similarity is equal to or more than the preset threshold, and
when there is a content being in the middle of output by the passenger outside the vehicle before the passenger enters the vehicle in the outside-vehicle output history,
the output control unit controls the content output unit to output the content being in the middle of output from the middle of output.

5. The content control device according to claim 1, wherein
when the similarity is less than the threshold,
the output control unit controls the content output by the content output unit, based on the in-vehicle output history.

6. The content control device according to claim 5, wherein
when the similarity is less than the threshold,
the output control unit controls the content output by the content output unit so as to preferentially output a type of a content whose number of occurrences of output is equal to or less than a predetermined number of times in the outside-vehicle output history, from among the types of the content involved in the in-vehicle output history.

7. The content control device according to claim 5, wherein
in a case where the similarity is less than the threshold,
when there are a plurality of types of the content whose number of occurrences of output is equal to or less than the predetermined number of times in the outside-vehicle output history, from among the types of the content involved in the in-vehicle output history, and
when the plurality of types of the content include a type of a content whose number of occurrences of output is zero in the outside-vehicle output history and a type of a content whose number of occurrences of output is one or more in the outside-vehicle output history,
the output control unit controls the content output by the content output unit so as to output the type of the content whose number of occurrences of output is one or more in the outside-vehicle output history in preference to the type of the content whose number of occurrences of output is zero in the outside-vehicle output history.

8. The content control device according to claim 5, wherein
when the similarity is less than the threshold, and
when there is the content being in the middle of output by the passenger outside the vehicle before the passenger enters the vehicle in the outside-vehicle output history,
the output control unit controls the content output by the content output unit so as to output, based on the in-vehicle output history, a content other than the content being in the middle of output.

9. The content control device according to claim 5, wherein
when the similarity is less than the threshold,
the output control unit controls the content output by the content output unit so as to output the type of the content whose number of occurrences of output is zero in the in-vehicle output history and the outside-vehicle output history.

10. The content control device according to claim 1, wherein
the history storage unit further classifies the content output by the content output unit as the in-vehicle output history according to each vehicle environment information including passenger information regarding the passenger of the vehicle that the passenger is in, and stores the number of occurrences of output of the content for each vehicle environment information in association with the passenger, and
the output control unit calculates the similarity indicating the degree of similarity between the in-vehicle output history corresponding to the vehicle environment information of the vehicle that the passenger is in and the outside-vehicle output history, and controls the content output by the content output unit according to the similarity.

11. The content control device according to claim 10, further comprising:
a passenger detection unit that detects a seating position of the passenger in the vehicle that the passenger is in, wherein
the vehicle environment information includes the seating position of the passenger detected by the passenger detection unit, and
the output control unit calculates the similarity indicating the degree of similarity between the in-vehicle output history corresponding to the seating position where the passenger is seated and the outside-vehicle output history, and controls the content output by the content output unit according to the similarity.

12. The content control device according to claim 10, further comprising:
a passenger detection unit that detects the number of passengers in the vehicle that the passenger is in, wherein
the vehicle environment information includes the number of passengers detected by the passenger detection unit,
when the number of passengers in the vehicle that the passenger is in is one,
the output control unit calculates the similarity indicating the degree of similarity between the in-vehicle output history corresponding to the case where the number of passengers in the vehicle is one and the outside-vehicle output history, and controls the content output by the content output unit according to the similarity, and
when the number of passengers in the vehicle that the passenger is in is many,
the output control unit calculates the similarity indicating the degree of similarity between the in-vehicle output history corresponding to the case where the number of passengers in the vehicle is many and the outside-vehicle output history, and controls the content output by the content output unit according to the similarity.

13. The content control device according to claim 12, wherein
the passenger detection unit detects passenger identification information, which is information for identifying the passenger in the vehicle that the passenger is in,
the vehicle environment information includes the passenger identification information of the passenger detected by the passenger detection unit, and
the output control unit calculates the similarity indicating the degree of similarity between the in-vehicle output history corresponding to the passenger identification information indicating the passenger other than the passenger detected by the passenger detection unit and the outside-vehicle output history, and controls the content output by the content output unit according to the similarity.

14. The content control device according to claim 10, further comprising:
a driving mode detection unit that detects a driving mode indicating whether the vehicle is being in automatic driving, wherein
the vehicle environment information includes the driving mode, and
the output control unit calculates the similarity indicating the degree of similarity between the in-vehicle output history corresponding to the driving mode of the vehicle and the outside-vehicle output history, and controls the content output by the content output unit according to the similarity.

15. The content control device according to claim 1, wherein
the outside-vehicle output history is classified according to each outside-vehicle environment information indicating an environment in which the passenger outputs a content outside the vehicle, and stores the number of occurrences of output of the content for each type of the content which is output outside the vehicle by the passenger,
the outside-vehicle history acquisition unit acquires the outside-vehicle output history corresponding to the outside-vehicle environment information indicating the environment in which the passenger outputs the content immediately before entering the vehicle, and
the output control unit calculates the similarity indicating the degree of similarity between the in-vehicle output history and the outside-vehicle output history, and controls the content output by the content output unit according to the similarity.

16. A content control method performed by a content control device,
the content control device including:
a content output unit that outputs a content to a passenger seated on a seat in a vehicle;
an output control unit that controls the content output by the content output unit;
a history storage unit that classifies the content output by the content output unit according to each of types of the content and stores, as an in-vehicle output history, the number of occurrences of output of the content for each of the types of the content in association with the passenger; and
an outside-vehicle history acquisition unit that classifies a content output outside the vehicle by the passenger according to each of types of the content and acquires, as an outside-vehicle output history, the number of occurrences of output of the content for each of the types of the content, wherein
the output control unit executes a content control step of calculating a similarity indicating the degree of similarity between the in-vehicle output history and the outside-vehicle output history, and controlling the content output by the content output unit according to the similarity.

17. A non-transitory computer readable storage medium storing a content control program causes a processor provided in a content control device arranged in a vehicle to function as:
a content output unit that outputs a content to a passenger seated on a seat in a vehicle;
an output control unit that controls the content output by the content output unit;
a history storage unit that classifies the content output by the content output unit according to each of types of the content and stores, as an in-vehicle output history, the number of occurrences of output of the content for each of the types of the content in association with the passenger; and
an outside-vehicle history acquisition unit that classifies a content output outside the vehicle by the passenger according to each of types of the content and acquires, as an outside-vehicle output history, the number of occurrences of output of the content for each of the types of the content, wherein
the output control unit calculates a similarity indicating the degree of similarity between the in-vehicle output history and the outside-vehicle output history, and controls the content output by the content output unit according to the similarity.

18. A content control system comprising:
a content control device; and
an information processing device communicably connected to the content control device,
the content control device including:
a content output unit that outputs a content to a passenger seated on a seat in a vehicle;
an output control unit that controls the content output by the content output unit; and
a history storage unit that classifies the content output by the content output unit according to each of types of the content and stores, as an in-vehicle output history, the number of occurrences of output of the content for each of the types of the content in association with the passenger, wherein
the content control device further includes an outside-vehicle history acquisition unit that classifies a content output outside the vehicle from the information processing device by the passenger according to each of types of the content and acquires, as an outside-vehicle output history, the number of occurrences of output of the content for each of the types of the content, and
the output control unit calculates a similarity indicating the degree of similarity between the in-vehicle output history and the outside-vehicle output history, and controls the content output by the content output unit according to the similarity.
